(19) United States
(12) Patent Application Publication
(10) Pub. No.: US 2025/0371337 A1
(43) Pub. Date: Dec. 4, 2025

(54) CONTEXTUALLY AUGMENTED TRANSFORMER NEURAL NETWORK

(71) Applicant: U.S. BANK NATIONAL ASSOCIATION, Cincinnati, OH (US)

(72) Inventors: Giacomo Domeniconi, Long Island City, NY (US); Kai-Min Kevin Chang, Pittsburgh, PA (US); Samuel Assefa, Washington, DC (US)

(21) Appl. No.: 18/733,264

(22) Filed: Jun. 4, 2024

(51) Int. Cl. G06N 3/08

(52) U.S. Cl. CPC G06N 3/08

(57) ABSTRACT

A contextually augmented transformer neural network is provided. Contextual data objects, such as subsequence contexts, token-level contexts, and token-to-token contexts, are embedded into an attention mechanism to provide the contextually augmented transformer neural network. The contextual data object is ingested with a sequence data object to improve attention mechanisms such as the query-key-value mechanism. The contextually augmented transformer neural network generates outputs based on input data including sequence data objects and contextual data objects. The contextual data object may be a different data type than the data included in the sequence data object and may not be a part of the sequence data object. The contextually augmented transformer neural network provides improved efficiency and accuracy in comparison to other neural networks.

### FIELD

The present application is generally related to systems, methods, apparatuses, and computer program products associated with a contextually augmented transformer neural network.

### BACKGROUND

Deep learning is an area of machine learning that utilizes neural networks to extract features from multiple layers, and iteratively applies the extracted features to additional layers of the neural network to extract additional features and meaningful information. Certain deep learning architectures utilize transformers to process sequences of data and to generate output or predictions from the sequence. For example, some natural language processing models utilize a transformer to process sequential text input, weight parts of the input, and extract meaning.

Training and operating a transformer neural network can be a resource-intensive task. Large language models and other types of transformers have a complex architecture and a large number of parameters to process and calculate. Accordingly, training and operating such transformers requires significant computational resources, such as processing resources and memory resources. Moreover, transformers are currently limited in their usefulness for some non-natural-language-processing applications. Through applied effort, ingenuity, and innovation, these processes are improved by developing solutions that are configured in accordance with the embodiments of the present disclosure, many examples of which are described in detail herein.

### SUMMARY

Embodiments of the present disclosure are directed to a system, computer readable medium, and computer-implemented method for generating, providing, and utilizing a contextually augmented transformer neural network.

A system is provided, the system comprising one or more processors and at least one non-transitory memory having instructions that, when executed by the one or more processors, cause the one or more processors to receive a subject sequence data object and one or more subject contextual data objects associated therewith. The instructions, that when executed by the one or more processors, further cause the one or more processors to access a contextually augmented transformer neural network comprising an attention mechanism, wherein the attention mechanism comprises a queries matrix, a keys matrix, and a values matrix.

The instructions, that when executed by the one or more processors, further cause the one or more processors to ingest the subject sequence data object and the one or more subject contextual data objects into the attention mechanism, and to embed the one or more subject contextual data objects in the attention mechanism. The instructions, that when executed by the one or more processors, further cause the one or more processors to generate, using the contextually augmented transformer neural network, an output associated with the subject sequence data object.

According to certain embodiments, the instructions, that when executed by the one or more processors, further cause the one or more processors to generate, based at least in part on the output, an electronic communication configured for display via a display device, and transmit the electronic communication to a computing device associated with a subject entity associated with the subject sequence data object.

Embedding the one or more subject contextual data objects in the attention mechanism comprises determining respective relevancies, based at least in part on the one or more subject contextual data objects, of one or more elements kin the keys matrix to each element q of the queries matrix. Determining the respective relevancies comprises generating weights of one or more elements of the attention mechanism based at least in part on the one or more subject contextual data objects, and applying the weights to the one or more elements of the attention mechanism.

The instructions, that when executed by the one or more processors, further cause the one or more processors to receive a plurality of training sequence data objects, and receive a plurality of one or more training contextual data objects associated with a respective one or more of the plurality of the training sequence data objects. The instructions, that when executed by the one or more processors, further cause the one or more processors to receive output labels for each of the plurality of the training sequence data objects and respective one or more training contextual data objects, and train the contextually augmented transformer neural network with the plurality of the training sequence data objects, the one or more training contextual data objects, and the output labels.

The subject sequence data object comprises one or more tokens derived from sequential data, and positional encodings indicating the one or more tokens' respective positions within the sequential data. According to certain embodiments, subject sequence data object may be derived from one or more transactional records. According to certain embodiments, the subject sequence data object is derived from one or more of natural language text, an image, or an audio file.

According to certain embodiments, the one or more subject contextual data objects comprise one or more subsequence contexts. The one or more subsequence contexts comprise one or more demographic attributes of a subject entity associated with the subject sequence data object. According to certain embodiments, the attention mechanism comprises a self-attention mechanism. The one or more subject contextual data objects comprise one or more token-level contexts. According to certain embodiments, the subject sequence data object is derived from a plurality of events, at least one of the token-level contexts applies to one or more of the plurality of events.

The one or more subject contextual data objects comprise one or more token-to-token contexts. The subject sequence data object comprises a plurality of events, and wherein the one or more token-to-token contexts comprise one or more contexts of one or more of the plurality of events relative to one or more contexts of one or more other events of the plurality of events. Embedding the one or more subject contextual data objects in the attention mechanism comprises adding the one or more subject contextual data objects to the queries matrix.

According to certain embodiments, embedding the one or more subject contextual data objects in the attention mechanism comprises generating an X matrix comprising rows corresponding to elements of the subject sequence data object, and columns corresponding to embedded features of the subject sequence data object, generating a vector C comprising the one or more subject contextual data objects, and aggregating the x matrix and the vector C, wherein the queries matrix, the keys matrix, and the values matrix are computed based at least in part on the aggregation of the X matrix, the vector C, and respective weights.

The system according to claim 1, wherein embedding the one or more subject contextual data objects in the attention mechanism comprises generating sequence-contextual embeddings by embedding the one or more subject contextual data objects with the subject sequence data object, and generating an X matrix comprising rows corresponding to the sequence-contextual embeddings, and columns corresponding to features of the sequence-contextual embeddings, wherein the queries matrix, the keys matrix, and the values matrix are computed based at least in part on the X matrix and respective weights, wherein the queries matrix, the keys matrix, and the values matrix are computed based at least in part on the X matrix.

A non-transitory computer readable medium is provided having instructions that, when executed by one or more processors, cause the one or more processors to receive a subject sequence data object and one or more subject contextual data objects associated therewith. The instructions that, when executed by one or more processors, further cause the one or more processors to access a contextually augmented transformer neural network comprising an attention mechanism, wherein the attention mechanism comprises a queries matrix, a keys matrix, and a values matrix. The instructions that, when executed by one or more processors, cause the one or more processors to ingest the subject sequence data object and the one or more subject contextual data objects into the attention mechanism, and embed the one or more subject contextual data objects in the attention mechanism. The instructions that, when executed by one or more processors, cause the one or more processors to generate, using the contextually augmented transformer neural network, an output associated with the subject sequence data object.

A computer-implemented method comprising receiving a subject sequence data object and one or more subject contextual data objects associated therewith, and accessing a contextually augmented transformer neural network comprising an attention mechanism, wherein the attention mechanism comprises a queries matrix, a keys matrix, and a values matrix. The computer-implemented method further includes ingesting the subject sequence data object and the one or more subject contextual data objects into the attention mechanism, embedding the one or more subject contextual data objects in the attention mechanism, and generating, using the contextually augmented transformer neural network, an output associated with the subject sequence data object.

An apparatus is provided with means for receiving a subject sequence data object and one or more subject contextual data objects associated therewith, and means for accessing a contextually augmented transformer neural network comprising an attention mechanism, wherein the attention mechanism comprises a queries matrix, a keys matrix, and a values matrix. The apparatus further includes means for ingesting the subject sequence data object and the one or more subject contextual data objects into the attention mechanism, means for embedding the one or more subject contextual data objects in the attention mechanism, and means for generating, using the contextually augmented transformer neural network, an output associated with the subject sequence data object.

Other embodiments include corresponding systems, methods, and computer programs, configured to perform the operations of the apparatus, encoded on computer storage devices. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system that can benefit from technologies described herein.

FIG. 2 illustrates an example method and operations associated with training a contextually augmented transformer neural network according to the present disclosure.

FIG. 3 illustrates a conceptual diagram of a contextually augmented transformer neural network according to the present disclosure.

FIG. 4 illustrates a data flow according to an attention mechanism of the present disclosure.

FIGS. 5-7 illustrate example methods and operations for embedding a contextual data object in an attention mechanism according to the present disclosure.

FIG. 8 illustrates an example method and operations for generating outputs according to the present disclosure.

FIG. 9 discloses an example computing environment with which aspects of the present disclosure may be implemented.

FIG. 10 illustrates an example machine learning framework that techniques described herein may benefit from or improve on.

FIG. 11 illustrates example sequences and transactional features, contextual features, and meta features upon which transaction predictions are made.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout.

### OVERVIEW

Embodiments of the present disclosure relate to transformer neural networks having improved self-attention mechanisms for improved natural language processing (NLP) and novel applicability and performance outside of NLP. For example, transformer neural networks may be used in many artificial intelligence (AI) applications, such as natural language processing tasks, computer vision tasks, and multimodal tasks. Transformers rely on a self-attention mechanism that, given a sequence of input data, understands the semantic of a current target query token of the input sequence (e.g., a word) by mapping it with a key-value pair with all other tokens of the sequence. In the NLP use case, this translates into the semantic meaning of a word given its surrounding words. Transformers have been applied to a variety of use cases, including time-series and transactional event sequences.

Transformers, and their underlying self-attention mechanism, ingest sequences of inputs. Traditional transformer approaches learn contextual information from data itself because it uses large amounts of unstructured data (e.g., raw text, images, etc). However, in certain cases (e.g., customer transactions, computer network logs, biosensor logs, etc.), more metadata is known about the entity (e.g., a customer or computer) and there is also concurrent information about the transaction or event (e.g., location and time) that can be used or learned. But traditional transformers are not designed to take as an input known contextual information that is not part of the sequence such as metadata or the like pertaining to a sequence or portion thereof. Nor are traditional transformers designed to input a known context of an element compared to other elements in the sequence. Some NLP transformers derive semantic context from the sequence itself and use the context to further derive meaningful information from the text input. In such examples, the semantic context is not input into the transformer or model as known data, but rather extracted from the text by the model. Lacking known contextual information, the transformer may be prone to generating incorrect outputs or requiring extensive training data sets to reach a sufficient accuracy.

Example embodiments of the present disclosure provide improvements to computing systems (e.g., improvements to or arrangements of transformer neural networks) that enable systems and methods to make predictions regarding sequences using contextual information. According to example embodiments of the present disclosure, an augmented transformer embeds contextual information, such as metadata, that is not a part of the input sequence along with the input sequence. As an example, the disclosed augmented transformer can be applied to transactional event sequences. A transformer neural network ingests the sequence of transactions associated with a user. The metadata or context related to a user (for example, the user's demographic, location, etc.) may be applied as contextual information that can increase the modeling capabilities of the sequence and all its inputs.

While many examples are described herein are transactional, embodiments need not be so limited. Further, while examples herein may involve transactional data, the present disclosure may not necessarily be directed to such transactions. Rather, embodiments are directed to improvements to computing systems in their ability to efficiently and effectively process data and produce useful output in ways that computing systems lacking such techniques cannot. For example, transformer neural networks augmented according to the augmented self-attention mechanism embodiments described herein may be generated (e.g., trained) more quickly and may produce more accurate results using less data than typical transformers due to more accurate focus provided by adding the contextual information to the self-attention mechanism. Similarly, the transformer neural networks augmented according to the augmented self-attention mechanism embodiment described herein may function for novel applications for which the contextual information provides improved usability, including but not limited to transaction data analysis and predictions such as cybersecurity analysis (e.g., predictions made based on network traffic data), recommendation systems, bio-sensor monitoring, and fraud detection (e.g., predictions made based on transaction sequences). At least some techniques described herein can be applied to improve the ability of a computer system to model or analyze behavior, such as by improving accuracy of classification and prediction. Techniques can be applied to fraud detection, churn analysis, cashflow forecasting, next category of purchase, other areas, or combinations thereof.

Some embodiments of the transformer neural networks according to the present disclosure may be configured to receive as inputs non-natural-language and/or non-textual input data (e.g., image data, numerical data, temporal data, other transactional data, etc.). Some embodiments of the transformer neural networks according to the present disclosure may be configured to receive an input sequence comprising data from multiple domains (e.g., two or more of image data, numerical data, temporal data, other transactional data, etc.). Some embodiments of the transformer neural networks according to the present disclosure may be configured to output textual or non-textual outputs, including computer program instructions configured to cause a computing system to carry out a resolution to an issue detected via the transformer neural network (e.g., locking a user account upon detection of fraud, cybersecurity, etc. risk).

Example embodiments the present disclosure embed the contextual information within the self-attention mechanism, such as by modifying a query-key-value mechanism of the transformer self-attention mechanism input layers. Example embodiments disclosed herein may modify the queries (Q) matrix of the self-attention mechanism or, in some embodiments, the keys (K) matrix. According to example embodiments disclosed herein, the query pairs single inputs from the input sequence plus the contextual information that is not a part of the input sequence.

The query-key-value mechanism is an attention mechanism that utilizes a set of matrices, including a queries (Q) matrix, keys (K) matrix, and values (V) matrix. According to certain system embodiments, the queries and keys function may represent a solution similar to: “For each element q in the queries matrix Q, what is the most related element k in the keys matrix K to q?” This creates a weight matrix of the mutual importance or relevance between each pair of events (how relevant or important is q for k?). In this regard, relevancy can be considered a measurable significance in one feature being a predictor of a particular output. The weight matrix is then scaled, applied to a normalized exponential function, such as SOFTMAX function, and then used to weight the importance of the values elements in relation to q. As used herein, SOFTMAX function is an example of a normalized exponential function, and it will be appreciated that alternative normalized exponential functions may be utilized accordingly to example embodiments provided herein in place of the SOFTMAX function.

The query-key-value mechanism works well in understanding and assigning semantic information among elements in sequences, such as words of a sentence. However, query-key-value mechanisms of existing systems lack the ability to adequately and efficiently leverage contextual or metadata information that is known, or knowable, and available and shared across all elements of the input, or contextual or metadata information related to an input sequence.

One approach to incorporate the metadata, or contextual information, into a query-key-values mechanism may be to concatenate the contextual information with each single input and with each feature embedding that is extracted from the transformer. Such an approach has extremely high redundancy, making consume significant computational resources in many contexts (e.g., because matrices involved in the computation will all be extended with metadata). In some instances, resource utilization is so high that computation cannot be reasonably performed on certain systems. Additionally, such a model is unlikely to understand and discern the single element information and the contextual information. Moreover, such an implementation that attempts to concatenate the contextual information in each single input would reflect the metadata being used independently from the single sequence element in all the three matrices of the self-attention (the queries matrix, the keys matrix, and the values matrix). Such a procedure might not lead to any improvement because of the possible lack of understanding from the neural network of which inputs are related to the single element of the sequence (e.g., a transaction transaction) and which ones are contextual metadata

Example embodiments of the present disclosure directly embed the contextual information within the attention mechanism as part of the query-value matching, as described in further detail herein. Certain example embodiments disclosed herein may modify one of the Q or K matrix flows with the context information, which may reduce redundancy that otherwise occurs according to other methods that may oversaturate the model with the contextual information, such as by adding the metadata onto the whole input X (or onto each of the individual vectors therein) and having that data permeate all three of the Q matrix, the K matrix, and the V matrix. According to example embodiments disclosed herein, the contextual information is selectively added to one or more of the Q matrix or K matrix. Since the three matrix flows are multiplied, the contextual information eventually makes its way into the output, without adding the overheard that could otherwise be incurred by adding the contextual information to the whole input X, and without skewing the attention mechanism in a way that adding the contextual information to the whole input X could otherwise skew the attention mechanism.

Example embodiments of the present disclosure modify the query-key-value mechanism by augmenting the transformer with contextual information that is not a part of the input sequence. For example, some example embodiments may change the keys matrix functionality of a query-key-value mechanism by answering: “For each element q in the queries matrix, given the contextual information C, what is the most related element k in the keys matrix to q?” Here, keys matric can refer to the “key” or K matrix in the query-key-value mechanism. The modification enables example embodiments to contextualize the lookup query functions of the keys-values weighting mechanisms, while the returned weighted vector V would be context agnostic. In some example embodiments, only one of the Q or K matrices (or data derived from or used to generate the same) may have the contextual information added thereto. In some examples, the Q matrix is updated. In some examples, the K matrix is also updated.

Certain example use cases are given for the application of the various embodiments disclosed herein, and one will appreciate, in light of the present disclosure, that these use cases, while improvements themselves, also provide examples of underlying improvements of the present disclosure (e.g., improved neural networks, neural network training, neural network weighting, etc.) that may be used with other use cases.

### Example Terminology

As used herein, the terms “data,” “content,” “digital content,” “digital content object,” “information,” and similar terms may be used interchangeably to refer to data capable of being transmitted, received, and stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and the like.

The term “sequential data” refers to any data representation having elements or records with at least one indicator of sequential relevancy to another element or records of the sequential data. For example, sequential data may refer to a transaction history comprising multiple transactions, where each transaction has an associated timestamp. Sequential data may refer to a journal article, in which each word or paragraph has a sequential indicator in comparison to other words or paragraphs of the journal article. Sequential data may refer to data with underlying elements comprising spatial relationships to other elements, such as an image, in which the pixels have a respective sequence relative to one another. Sequential data may refer to an audio file, in which audio elements have a respective sequence relative to one another. Sequential data may refer to health data obtained by implanted, wearable, or external sensors, including movement data (e.g., steps per day, activity level, and gait characteristics), sleep data (e.g., hours and quality of sleep), organ function data (e.g., heart rate), biological markers (e.g., blood glucose levels), other health data (e.g., weight), or combinations thereof, where the health data has an associated timestamp. Sequential data may refer to interactions with a computing device, such as but not limited to webpages visited, products viewed, items added into digital cart, cart items abandoned, etc.

The term “sequence data object” refers to a token (or in some implementations a set of one or more tokens) and its respective positional encodings indicating the token's respective positions within a collection. The tokens are derived from sequential data, and the positional encodings indicate the respective position of the token within the sequential data. In natural language processing, the position of an element (e.g., a word or token) refers simply to its position in a work (e.g., a sentence). In other domains like transactional data, positional encoding can be specified as its position within an order. The collection may therefore be considered an ordered collection, such as based on the respective positional encodings of the tokens that make up the sequence data object. In certain embodiments, an instance of a sequence data object includes tokens of a single type. For example, an instance of a sequence data object may include a collection of tokens that are linguistic elements, transaction amounts, biosensor readings, or other types.

Another instance of a sequence data object may include a collection of tokens that are events or attributes thereof. In some examples, each element of a collection can be considered a single type (e.g., a transaction type), but elements of the collection may have different class or meaning from each other. For example, there may be a sequence of elements having a transaction type that are a mix of purchases, payments to the credit card, refunds, fee, and non-monetary transactions (e.g., account opening). The type as well as some other information (e.g., the amount or the time) may be seen as features of each element. The features are one of the dimensions (the columns) of the input matrix X, described in further detail herein. In some examples, the elements can be of different types. In some examples, there can be different formats of data, such as text, images, and audio. The data may be converted into a single format for processing. A sequence data object may be generated based on times an event or transaction occurred. For example, a database may have an insertion timestamp, a modification timestamp, or the like associated with a dollar amount. The dollar amounts may then be ordered according to the times to form a sequence data object.

A “subject sequence data object” therefore refers to a sequence data object applied to a contextually augmented transformer neural network, or to be applied to a contextually augmented transformer neural network, to generate an output. A subject sequence data object may be associated with a subject entity, such as a particular user. A “training sequence data object” refers to a sequence data object, such as for which an output label is known and utilized in training a contextually augmented transformer neural network as described herein. A sequence data object (including but not limited to a subject sequence data object and a training sequence data object) may include a sequence or ordered collection of events and may be derived from sequential data such as a credit card transaction history, account history, biosensor readings, or the like.

The term “token” refers to a data representation of an element or a unit of data that makes up at least a portion of a sequence data object. A token may be derived from sequential data. Each token has a respective positional encoding describing the token's relationship to other tokens in the sequence data object. According to certain example embodiments, a token may be generated by tokenizing a larger set of data, such as sequential data. For example, a paragraph, an audio file, an image, a transactional history, and the like may be tokenized to generate the tokens.

A token may include a linguistic unit such as a character(s), a word(s), or any combination thereof, that has a positional encoding describing its position relative to other linguistic units. A token that includes a linguistic unit may be derived from a natural language sequence such as content of an email, a journal article, or the like. A token may include an image patch or collection of patches derived from an image, and that has a positional encoding describing its position relative to other patches of an image. A token may include an audio element derived from an audio file that has a positional encoding describing its position relative to other units of audio data in the audio file. A token may include a database record or attribute thereof, derived from a data source, such as a database table or other computer-implemented storage, which has a sequential relationship to other records in the data source. For example, a database may have an insertion timestamp, a modification timestamp, or the like associated with a dollar amount.

A token may include a data representation of an event or attribute thereof, that has a positional encoding describing a time occurrence relative to other tokens of a sequence. A token that includes data representative of an event or attribute thereof may be derived from any sequence of events. For example, tokens including data representations of an event or attribute thereof may be derived from a transactional history comprising a plurality of events associated with or indicative of transactions. As another example, tokens including data representations of an event or attribute thereof may be derived from a machine maintenance log, in which maintenance events are logged along with a timestamp.

The term “event” refers an identifiable, non-transitory occurrence that has technical significance for one or both of system hardware and software. An event may be user-generated, such as by keystrokes or mouse movements, such as those that results in or are associated with approval of a purchase, confirmation of an investment, swiping of a credit card, positioning of a credit card including a chip to be read by a chip-reader, etc. An event may be associated with a transaction and may have an associated timestamp. Such transactions reflect numerous transactional data and may be obtained from a transactional data source. As another example, an event may be associated with an operation, such as a maintenance operation performed on one or more machines, and may have an associated timestamp.

The term “transactional data” refers to sequential data comprising a quantifiable monetary feature. Examples of transactional data may include purchases, withdrawals, contributions, etc. The transactional data may include an amount, a retailer name, a category and optional subcategory of the retailer, a financial institution responsible for performing any of the payment processing or disbursement, identifying information of the entity that initiated the associated transaction, and the like. The transactional data is therefore representative of one or more events having respective quantifiable features and may be associated with respective timestamps so a sequence data object can be derived therefrom.

The term “transactional data source” refers to a system affiliated with a transaction system (e.g., a financial transaction system, a retail transaction system, another kind of transaction system, or combinations thereof) and configured to store, maintain and provide transactional data. The transactional data source may be affiliated with or operated by a bank, lender, credit card company, investment institution, or the like, such as one that issues credit cards to cardholders, and facilitates authorization, settlement and funding.

The term “subject entity” refers to one or more individuals, joint account owners, families, business, etc. with which a subject sequence data object and contextual data object is associated and may include any identifying information of thereof such as unique identifiers, combinations of data such as name and date of birth, and the like. A subject entity may be associated with a subject entity identifier. A subject entity identifier may refer to one or more items of data by which a subject entity may be uniquely identified. A subject entity may have an associated profile or entity profile data including demographic information and the like.

The term “timestamp” refers to any data representation of a date, a time, or combination thereof (e.g., a network timestamp).

The term “transformer” or “transformer neural network” refers to a deep learning framework that inputs a sequence data object to produce an output. The transformer neural network may include a data representation of nodes (e.g., neural network nodes, decision tree nodes, other nodes, or combinations thereof) and connections between nodes (e.g., weighted or unweighted unidirectional or bidirectional connections). In certain embodiments, the transformer neural network includes a representation of memory (e.g., providing long short-term memory functionality). The transformer neural network include an attention mechanism (e.g., a self-attention mechanism), and the transformer neural network may include one or more neural networks (e.g., feed-forward neural networks) configured to receive the output of the attention mechanism (e.g., one or more attention vectors) for analysis. The transformer may be configured to output probabilities or other data and may be combined with one or more other computer executable instructions.

The term “attention mechanism” refers to a collection of data and software of the transformer neural network that allows the transformer neural network to focus on and assign attention weights to specific portions of input, such as a portion(s) of a sequence data objects, certain tokens, and the like. The attention mechanism may generate one or more inputs (e.g., attention vectors) to a neural network (e.g., a feed-forward neural network). The attention mechanism may be employed during the training of the neural network to generate the weights and store the weights in an attention map to be used during application of the neural network to real-world data in order to generate output. The attention mechanism may include self-attention layers, or the like. The attention mechanism may include a query-key-value mechanism. According to example embodiments disclosed herein, an attention mechanism of a contextually augmented transformer neural network includes one or more contextual data objects embedded therein.

The term “query-key-value mechanism” refers to an attention mechanism that includes at least one of each of a queries matrix, a keys matrix, and a values matrix. The query-key-value mechanism further includes a mapping of the queries matrix and key-value parts to an output matrix. The key-value pairs are derived from the keys matrix and a values matrix. A query-key-value mechanism is used to extract meaning from sequential data, such as sequence data objects. According to example embodiments disclosed herein, a query-key-value mechanism of a contextually augmented transformer neural network includes one or more contextual data objects embedded therein. Query-key-value mechanisms are described in more detail in Vaswani et al, Attention Is All You Need, arXiv:1706.03762 (Jun. 12, 2017), which is incorporated herein by reference in its entirety for any and all purposes.

The term “queries matrix” is an element of the query-key-value mechanism that represents the tokens of a sequence data object.

The term “keys matrix” is an element of the query-key-value mechanism that indicates information against which queries are compared and enables the contextually augmented transformer neural network to determine relevant parts of the sequence data object.

The term “values matrix” is an element of the query-key-value mechanism that stores representations or embeddings of a token and can be retrieved by the contextually augmented transformer neural network based on the queries matrix and the keys matrix.

The term “contextually augmented transformer neural network” refers to an improved transformer provided according to embodiments of the present disclosure, which includes an attention mechanism in which the one or more contextual data objects is embedded. Training and use of the contextually augmented transformer neural network is described herein.

The term “sequence-contextual embedding” refers to a data representation of the one or more contextual data objects embedded with a sequence data object.

The term “contextual data object” refers to a data representation of information, such as contextual information, contextual data, context, metadata, or the like, associated with a sequence data object, such as the subject sequence data object. According to certain embodiments, the contextual data object is not a part of the sequence data object and may, in some embodiments, not include sequence data. According to certain embodiments, the contextual data object is not inherent in the sequence data object, nor can be derived or inferred from the sequence data object alone. The contextual data object may be associated with the sequence data object by way of another data entity, such as for example, a subject entity such as a user. In this regard, contextual data associated with a user is associated with a sequence data object that is associated with the same user. Contextual information can be information available “outside” of the sequence that may help to better contextualize the sequence itself. Though, where transformers are used, the system can also derive semantic context from the sequence.

A contextual data object may be in a different format than a format of a token, a different format than a format of an event, and a different format than a format of the sequence data object or data therein. For example, an event such as a transaction from which the tokens and sequence data object is derived, may include a quantifiable amount that is a dollar amount, among other attributes. However, a contextual data object associated with the sequence data object (or an entity associated with the sequence data object) may lack a quantifiable amount that is a dollar amount. If a contextual data object is associated with the subject entity (e.g., the contextual data object is or includes a profile attribute), the contextual data object may be relevant for a portion or entirety of the sequence data object.

A “subject contextual data object” refers to a contextual data object associated with a subject entity, or a sequence data object associated with the subject entity. A contextual data object may include one or more subsequence contexts, token-level contexts, or token-to-token contexts, described in further detail below.

The term “subsequence context” refers interchangeably to a macro level context or macro level metadata or meta features that are stable for a continuous subsequence of a sequence data object or sequential data, or for an entire sequence. Different subsequences of a sequence data object may therefore have different subsequence contexts associated therewith. For example, a subsequence context may be known for a time period or duration but may change over time. The subsequence or time period may therefore be associated with one or more continuous plurality of tokens, events, transactions or the like. A subsequence context is therefore relevant for an entity or a sequence data object for longer than a single time instant. According to certain embodiments, although a timestamp could indicate the start or end of a subsequence context, a subsequence context is not defined by a single time instant or single timestamp, but rather is defined, at least in part, by a period of time. A subsequence context may represent a long-term relationship between multiple tokens and the subject entity, or between the multiple tokens and the sequence data object.

According to certain embodiments, a subsequence context, or meta feature, is not derived from the sequence itself nor is derivable from the sequence itself. The subsequence context may be obtained from a database or data source that is separate from a data source from which the sequence is obtained. For example, when the sequence data object is obtained from a transactional database, one or more subsequence contexts may be obtained from a separate data source, such as a user profile data source, a third party data source, or the like.

A subsequence context may include any demographic information associated with an entity, such as age or address, a credit score, or any user profile attributes associated with the entity that is known for more than a single time instant. For example, a subsequence context, or meta feature, may include an education status such as “attending college” or “post-graduation.” A subsequence context may include a characteristic of an individual, such as an activity level (e.g., moderate activity level, sedentary activity level, etc.)

When a sequence data object is derived from events or a transaction history associated with an entity, the demographic information (the subsequence context) of the entity may not be a part of the transaction history or the sequence data object, but it is associated with the transaction history and the sequence data object. The demographic information that is the subsequence context is relevant for a plurality of transactions occurring over the time period during which the subsequence context is relevant or known. In some embodiments, subsequence context may remain constant during a sequence of events. In some embodiments, subsequence context may change during a sequence of events.

In example embodiments in which the sequence data object is derived from a paragraph, a subsequence context could be a chapter title or chapter number from which the paragraph is taken. In this regard, the chapter title or chapter number is associated with the paragraph (and the sequence data object) but is not a part of the sequence data object. In an embodiment in which the sequence data object is derived from an image, a subsequence context could be a title of a webpage from which the image was accessed or obtained. In this regard, the title of the webpage is associated with the image (and the sequence data object) but is not a part of the image or the sequence data object.

The term “token-level context” refers interchangeably to a contextual feature, micro level context or micro level metadata relevant to one or more tokens or events but defined based on an individual relationship to a token or event. A token-level context may therefore be relevant only for a single time instant or may be associated with a timestamp. For example, a token-level context may include a current context (e.g., time, location) of a transaction. A token-level context may include a time or timestamp that such an element occurred, was measured, created, or another relevant instance (e.g., when an event, such as a transaction, was made).

However, it should be appreciated that a token-level context can occur at multiple different time instances and may therefore apply to different tokens or events in a sequence but may be relevant on an individual basis (rather than an extended time period or subsequence covering multiple tokens or events). The token-level context may therefore be different from token to token or from event to an event within a sequence, or within a sequence data object. The token-level context may have more variance across a sequence data object than a variance of a subsequence context. The token-level context may represent a short-term, or one-time-instant characteristic of a token or an event.

For example, in NLP, a token-level context may be a font of an individual word. The font is a context of the individual word but may not be a part of the sequence data object that may include raw text without fonts or formatting.

As another example, a user device location, or global positioning system (GPS) location of a device at a time a transaction or event occurred may be a token-level context. The device location may be captured separately than an event or transaction data from which the sequence data object is derived, and may be correlated by a timestamp, for example. In this regard, a token-level context may be referred to as an event-level context.

A token-level context, or contextual feature may include a current location, a nearby merchant, a transaction date, a transaction time, or the like. Numerous other examples of token-level context may be contemplated.

The term “token-to-token context” refers to a context or a metadata of an individual token relative to other tokens. According to certain embodiments, token-to-token context refers to a context or a metadata of an individual token relative to one or more other tokens of the sequence data objects or one set of sequence data objects relative to another. According to certain embodiments, such as when the tokens are derived from transactions, a token-to-token context may include an ordering of purchases by token value (e.g., dollar amount), from highest cost to lowest cost. According to certain example embodiments, when a context of a token is considered relative to all other tokens of a sequence data object, the token-to-token context may be referred to as a token-to-sequence context. For example, a transaction identified as the highest cost transaction in all of sequence data object may have an associated token-to-sequence context indicating it as such. According to certain embodiments, a token-to-token context may be interchangeably referred to as a transactional feature, a transaction amount, a reading, a measurement, or the like.

The term “output” refers to a data object indicative of a prediction generated by the contextually augmented transformer neural network. Outputs generated by a contextually augmented transformer neural network may be associated with a variety of domains, may vary according to implementation, may have varying levels of granularity, and may include various attributes. Examples of outputs are described in further detail herein.

As set forth above, the contextually augmented transformer neural network may be implemented in a variety of ways to generate a multitude of outputs associated with various domains. An output may have varying levels of granularity and may have different attributes. In general, the output includes a prediction about a sequence data object.

According to certain embodiments, an output attribute may include a probability, indicating a probability that, given the sequence data object and one or more contextual data objects, a particular prediction is generated, such as a predicted category, a predicted classification, a predicted quantifiable feature, or the like. An output attribute may include an output distribution indicating a plurality of probabilities of respective categories or classifications. According to certain embodiments, an output attribute may include a confidence level that certain output attributes are accurate.

Numerous variations of output attributes may be contemplated. In certain example embodiments, such as those in which the contextually augmented transformer neural network processes tokens that are linguistic units, output attributes may include a natural language summary, a translation, an answer to a question, or the like. In certain example embodiments, such as those in which the contextually augmented transformer neural network processes tokens that are audio elements, outputs or attributes thereof may include an audio file classification, or the like. In certain example embodiments, such as those in which the contextually augmented transformer neural network processes tokens that are image patches, output or attributes thereof may include a recognized object in the image, an image classification, or the like. In some examples, biosignals are used.

In certain example embodiments, such as those in which the contextually augmented transformer neural network processes tokens including data representations of an event or attribute thereof, the output may include a prediction indicating a pattern change or trend change in such events in the future, for a type of data captured in a sequence data object. A “pattern change” therefore refers to an identifiable change in an attribute of a token or event over time. A pattern change prediction threshold may be used to determine whether a predicted change is significant enough for another action to occur or to be triggered. A pattern change prediction threshold is discussed in further detail herein.

Considering transactional records, an output attribute indicating a pattern change may include a directional indicator, a change type (a category and optional subcategory), a predicted start date or time, a predicted duration, a quantifiable feature, a predicted deviation of the quantifiable feature, a predicted number of events, and a predicted number of events per unit of time. According to certain embodiments, an output attribute may include a probability that a pattern change occurs or does not occur. In one example, techniques can be used for element classification (e.g., assigning a specific class or label to each, or some, elements of the input sequence). Such a technique can be used for fraud detection (e.g., one or more inputs in the sequence of transactions are marked as frauds), among other uses.

In some examples, techniques described herein can be used for element classification (e.g., assigning a specific class or label to each, or some, elements of the input sequence), such as for fraud detection (e.g., one or more inputs in the sequence of transactions are marked as frauds) or for classifying a medical biosensor reading as indicative of a health condition.

The term “directional indicator” refers to an indication of an increase or decrease, such as a predicted increase or predicted decrease of a quantifiable feature (described in further detail below) indicated by the output.

The term “change type” refers to a category and an optional subcategory describing a pattern change, or predicted pattern change in a sequence, such as a sequence of transactions, spending, or the like. A category may include any classification to which the change applies, such as but not limited to spending, deposits, withdrawals, speed, etc. As examples, subcategories associated with a spending category may include dining spending, home improvement spending, childcare spending, child related spending, etc. Subcategories associated with deposits or withdrawals may include stock, mutual fund, retirement accounts, etc.

The term “predicted start date or time” refers to a date or time (e.g., a network time stamp) the pattern change in the sequence is predicted to begin.

The term “predicted duration” refers to an estimated time period of a predicted pattern change. For example, the predicted duration may reflect a time duration of discernable change in a sequence, before the pattern reflects a pattern of a sequence prior to the predicted pattern change. Additionally or alternatively, an output attribute may include a predicted end date or end time of the predicted pattern change. According to example, a predicted pattern change may include an increase in spending for a predicted duration of one year, for example.

The term “quantifiable feature” refers to a feature measurable in a numeric representation. For example, a quantifiable feature may include dollars spent, dollars invested, dollars withdrawn, a production output of a machine, a desirability scoring of a text input, audio input, or image input for a particular user, or the like.

The term “predicted deviation of the quantifiable feature” refers to an estimated quantifiable change in the quantifiable feature in comparison to the quantifiable feature prior to a start of a predicted pattern change. For example, a predicted deviation of a quantifiable feature may be a $3,000 per year predicted increase in purchases in the home improvement category. An example predicted deviation of the quantifiable feature may include a prediction that a number of events, or transactions, will differ from a current or prior trend of events, or transactions for an entity, such as an increase in purchases in the home improvement category by 4 transactions per month.

The term “predicted number of events” refers to a quantity of events estimated to occur with regard to a predicted pattern change.

The term “predicted number of interactions per unit of time” refers to a quantity of interactions estimated to occur within a specified time period, regard to a predicted pattern change. For example, a predicted number of interactions per unit of time may include 10 transactions per month. As another example, a pattern change may include an increase of an average of 5 social media postings per day made by a particular user, in comparison to average postings in a prior month.

In this regard, the output may include a plot or curve including a predicted number of interactions per unit of time over a duration, a total of a quantifiable feature per unit of time over a duration (e.g., dollars spent per month), etc. which may vary in particular subperiods or timeframes. Accordingly, any data representations and any combinations of attributes, such as a directional indicator, a change type, a predicted start time, a predicted duration, a quantifiable feature, a predicted deviation of a quantifiable feature, a predicted number of interactions, a predicted number of interactions per unit of time, etc. may be included in predicted pattern change. The pattern change, from a current or prior trend of interactions may be predicted to occur in a future sequence of interactions, in one or more of the quantifiable features, the predicted number of interactions, or the predicted number of interactions per unit of time.

The term “pattern change prediction threshold” refers to a measurable data component used for comparison of outputs of the contextually augmented transformer neural network to determine whether a pattern change is predicted. For example, if a pattern change prediction threshold is a change in spending by at least $2,000 per year, and an output produced by the contextually augmented transformer neural network includes a predicted change of $3,000 per year, a pattern change prediction is generated and output, and optionally includes an indicator set to ‘true,’ but if an output includes a predicted change of $500 per year, a pattern change prediction is not generated nor output, or is generated and output with an indicator set to ‘false.’ According to certain embodiments, the threshold or condition may be defined by a probability output by the contextually augmented transformer neural network.

The term “output label” refers to a variation of an output or output label but includes known and true data associated with a one or more training series data objects and a respective entity. The output label may therefore include any attributes included in an output and is used to train the contextually augmented transformer neural network to generate other outputs based at least in part on a sequence data object and one or more contextual data objects. According to certain embodiments in which a specific type of classification (e.g., predicted pattern change) is being made, an output label may indicate ‘false,’ indicating no prediction of that type was identified. Accordingly, some output attributes may be ‘null.’ Such an output label may be included in the training method or excluded from the training method.

The term “electronic communication” refers to electronic data configured to be transmitted from one computing device to another computing device. The electronic communication may be readable the receiving device to produce output discernable by a user. For example, the electronic communication can include electronic mail, secure messaging, rendering by an application or website, etc.

### Example System Architecture

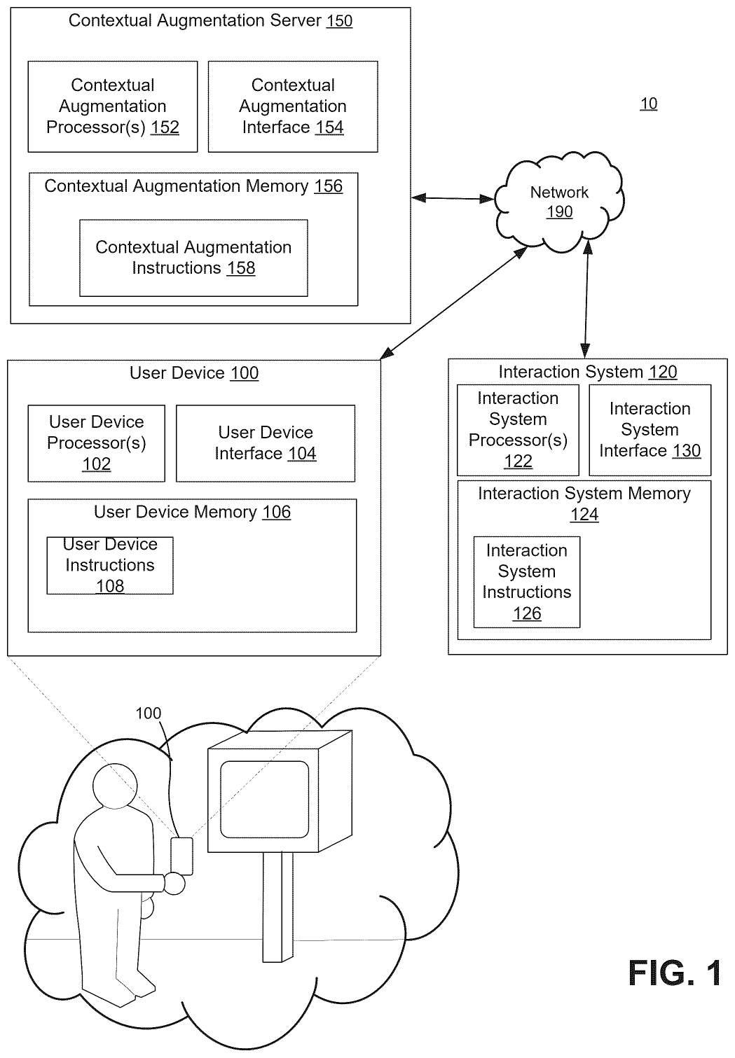

Methods, apparatuses, and computer program products of the present disclosure may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile devices, personal computer, laptop computer, tablet, or the like. An example system that can be used according to examples herein is described in FIG. 1.

FIG. 1 illustrates a system 10 configured to facilitate the generation of output by the contextual augmentation server 150, according to example embodiments. The system includes one or more user devices 100, one or more interaction systems 120, and one or more contextual augmentation servers 150 connected to a network.

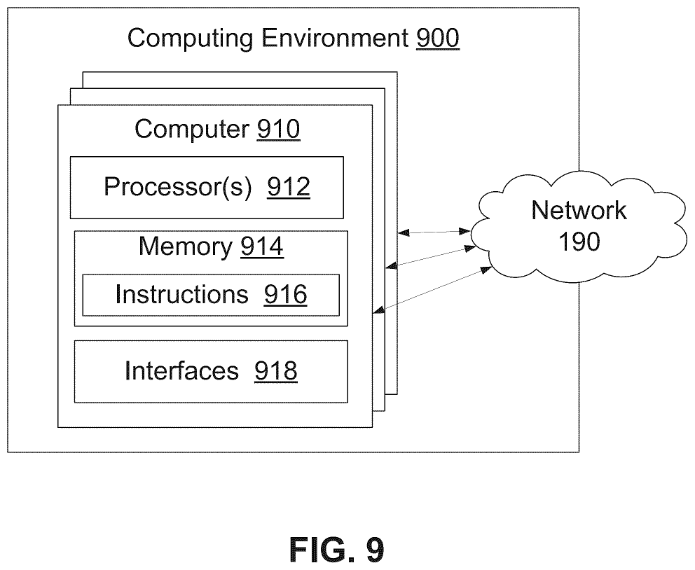

The user device 100 is a device used by a user that can be used as part of processes described herein. The user device 100 can include one or more aspects described elsewhere herein such as in reference to the computing environment 900 of FIG. 9. In many examples, the user device 100 is a personal computing device, such as a smart phone, tablet, laptop computer, or desktop computer. But the device 100 need not be so limited and may instead encompass other devices used by a user as part of processes described herein. For instance, with respect to data creation, other devices can generate data or cause data to be generated, such as credit cards, cash, digital wallets, or smart televisions, other devices, or combinations thereof. Communicating information pertaining to an output of a system (e.g., a prediction), communication may be provided via the user device 100, physical mail, phone calls, etc.

In the illustrated example, the user device 100 can include one or more user device processors 102, one or more user device interfaces 104, and user device memory 106, among other components.

The one or more user device processors 102 are one or more components of the user device 100 that execute instructions, such as instructions that obtain data, process the data, and provide output based on the processing. The one or more user device processors 102 can include one or more aspects described below in relation to the one or more processors 912 of FIG. 9.

The one or more user device interfaces 104 are one or more components of the user device 100 that facilitate receiving input from and providing output to something external to the user device 100. The one or more user device interfaces 104 can include one or more aspects described below in relation to the one or more interfaces 918 of FIG. 9.

The user device memory 106 is a collection of one or more components of the user device 100 configured to store instructions and data for later retrieval and use. The user device memory 106 can include one or more aspects described below in relation to the memory 914 of FIG. 9. As illustrated, the user device memory 106 stores user device instructions 108 and the user device code 110.

The user device instructions 108 are a set of instructions that, when executed by one or more of the one or more user device processors 102, cause the one or more user device processors 102 to perform an operation described herein. In examples, the instructions 112 can be those of a mobile application (e.g., that may be obtained from a mobile application store, such as the APPLE APP STORE or the GOOGLE PLAY STORE). The mobile application can provide a user interface for receiving user input from a user and acting in response thereto. The user interface can further provide output to the user. In some examples, the user device instructions 108 are instructions that cause a web browser of the user device 100 to render a web page associated with a process described herein. The web page may present information to the user and be configured to receive input from the user and take actions in response thereto.

The interaction system 120 is any computing device that facilitates interactions via the user device 100. In this regard, the user device 100 may be a client device in communication with an interaction system 120 implemented as a server. The interaction system 120 may further provide data to the contextual augmentation server 150 to enable the contextually augmented transformer neural network to be trained and to generate outputs, as described in further detail herein. For example, the interaction system 120 may provide sequential data, sequence data objects, tokens, events, transactional records, and contextual data objects to the contextual augmentation server 150, or any data from which sequential data, sequence data objects, tokens, events, transactional records, and contextual data objects are derived.

According to certain embodiments, the interaction system 120 may be embodied as a distributed system. According to certain embodiments, different instances of an interaction system 120 may be configured to provide different types of data to the contextual augmentation server 150. For example, an instance of an interaction system 120 may be a system that stores user profile data, demographic data, or the like, and may be configured to provide associated contextual data objects to the contextual augmentation server 150. Another instance of interaction system 120 may be a transactional system configured to provide sequential data pertaining to transactions, a transactional history, event history, tokens pertaining to transactions, a sequence data object and the like. In this regard, tokenization of sequential data, a transaction history, or the like may be performed by the interaction system 120, or the contextual augmentation server 150.

In the illustrated example, the interaction system 120 includes one or more interaction system processors 122, interaction system memory 124, and an interaction system interface 130.

The one or more other interaction system processors 122 are one or more components of the interaction system 120 that execute instructions, such as instructions that obtain data, process the data, and provide output based on the processing. The one or more interaction system processors 122 can include one or more aspects described below in relation to the one or more processors 912 of FIG. 9.

The interaction system memory 124 is a collection of one or more components of the interaction system 120 configured to store instructions and data for later retrieval and use. The interaction system memory 124 can include one or more aspects described below in relation to the memory 914 of FIG. 9. The interaction system memory 124 can store interaction system instructions 126.

The interaction system instructions 126 are instructions that, when executed by the one or more interaction system processors 122, cause the one or more interaction system processors 122 to perform one or more operations described elsewhere herein.

The one or more interaction system interfaces 130 are one or more components of the interaction system 120 that facilitate receiving input from and providing output to something external to the interaction system 120. The one or more interaction system interfaces 130 can include one or more aspects described below in relation to the one or more interfaces 918 of FIG. 9.

The interaction system 120 may be implemented for a variety of uses and in association with a variety of domains. For example, the interaction system 120 may host one or more applications on behalf of a business or organization. According to certain example embodiments, the interaction system 120 includes a financial system, such as or including a transactional system that facilitates the purchasing of goods, services and the like by various entities. The interaction system 120 may be operated by a bank, lender, credit card company, financial institution, investment institution, or the like, such as one that issues credit cards to cardholders, and facilitates authorization, settlement and funding. The interaction system 120 may further facilitate communication and transactions with one or more payment processors, merchant banks, merchant accounts, or the like, and may accept payments from cardholders to be credited towards a cardholders' debt. According to certain embodiments, the interaction system 120 may facilitate transactions associated with one or more bank accounts, such as a checking or savings account. According to certain embodiments, the interaction system 120 may facilitate brokerage transactions, mutual fund transactions, and the like.

In any event, the interaction system 120, such as a transactional system, may maintain and update various records associated with user interactions, including transactional records, monetary records, purchase history, investment records, account openings, account closures, and the like, in interaction system memory 124. According to certain embodiments the data may be associated with an individual, or another entity.

According to certain embodiments, the user device 100 need not interact directly with the interaction system 120, but the user device 100 may interact with one or more intermediary systems, such as retailer's website, which in turn communicates with the interaction system 120. For example, a user device 100 may initiate purchases via one or more websites using a credit or debit card, and an associated transaction is routed and processed by the website, merchant, payment processor, and the like. The data stored in the interaction system memory 124 may therefore be associated with transactional and monetary data but is further associated with user interactions made via user device 100.

An interaction system 120 may include an application server configured to facilitate creation and modification of a user profile, user demographic information and the like. A user may therefore use the user device 100 to indicate a marital status, address change, familial status, employment status, or the like. Accordingly, the interaction system memory 124 may include data indicating such statuses.

An interaction system 120 may receive data from one or more systems or generate new types of data based on other types of data. For example, an interaction system 120 may receive a credit score from another system associated with a credit reporting agency or credit bureau. In this regard, a credit score is associated with underlying interactions or transactions made by a user with an interaction system 120. As another example, an interaction system 120 may generate an estimated credit score based at least in part on transactions processed and stored by interaction system 120.

An interaction system 120 may be a social media system configured to receive text input, image input, and video input from a user. An interaction system 120 may include a website that publishes journal articles or the like. In this regard the interaction system 120 may be associated with any website, server, or system configured to receive a user input that includes any form of sequential data.

According to certain embodiments, the interaction system 120 may be operated by a same business entity as the contextual augmentation server 150. However, according to certain embodiments, the interaction system 120 may be operated by a different business entity as the contextual augmentation server 150, such that the interaction system 120 is a third-party system or external system. In this regard, the interaction system 120 may process and store any data pertaining to user interaction with a device, by one or more individuals or entities. The interaction system 120 may therefore include one or more public record systems, marketing systems, or the like.

The contextual augmentation server 150 is a server that functions as part of one or more processes described herein. In the illustrated example, the contextual augmentation server 150 includes one or more contextual augmentation processors 152, one or more contextual augmentation interfaces 154, and contextual augmentation memory 156, among other components.

The one or more contextual augmentation processors 152 are one or more components of the contextual augmentation server 150 that execute instructions, such as instructions that obtain data, process the data, and provide output based on the processing. The one or more contextual augmentation processors 152 can include one or more aspects described below in relation to the one or more processors 912 of FIG. 9.

The one or more contextual augmentation interfaces 154 are one or more components of the contextual augmentation server 150 that facilitate receiving input from and providing output to something external to the contextual augmentation server 150. The one or more contextual augmentation interfaces 154 can include one or more aspects described below in relation to the one or more interfaces 918 of FIG. 9.

The contextual augmentation memory 156 is a collection of one or more components of the contextual augmentation server 150 configured to store instructions and data for later retrieval and use. The contextual augmentation memory 156 can include one or more aspects described below in relation to the memory 914 of FIG. 9. The contextual augmentation memory 156 can store contextual augmentation instructions 158.

The contextual augmentation memory 156 may further include a contextually augmented transformer neural network, trained by the contextual augmentation server 150 according to example embodiments disclosed herein.

The contextual augmentation instructions 158 are instructions that, when executed by the one or more contextual augmentation processors 152, cause the one or more contextual augmentation processors 152 to perform one or more operations described elsewhere herein.

The network 190 is a set of devices that facilitate communication from a sender to a destination, such as by implementing communication protocols. The network 190 is a set of devices that facilitate communication from a sender to a destination, such as by implementing communication protocols. Example networks 190 include local area networks, wide area networks, private networks such as an intranet, public networks such as the Internet, or any combination thereof. The network 190 may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network 190 may include a cellular telephone, an 802.11, 802.16, 802.20, or WiMax network. The network 190 may utilize a variety of networking protocols now available or later developed including, but not limited to Transmission Control Protocol, Internet Protocol, etc.

### Example Methods

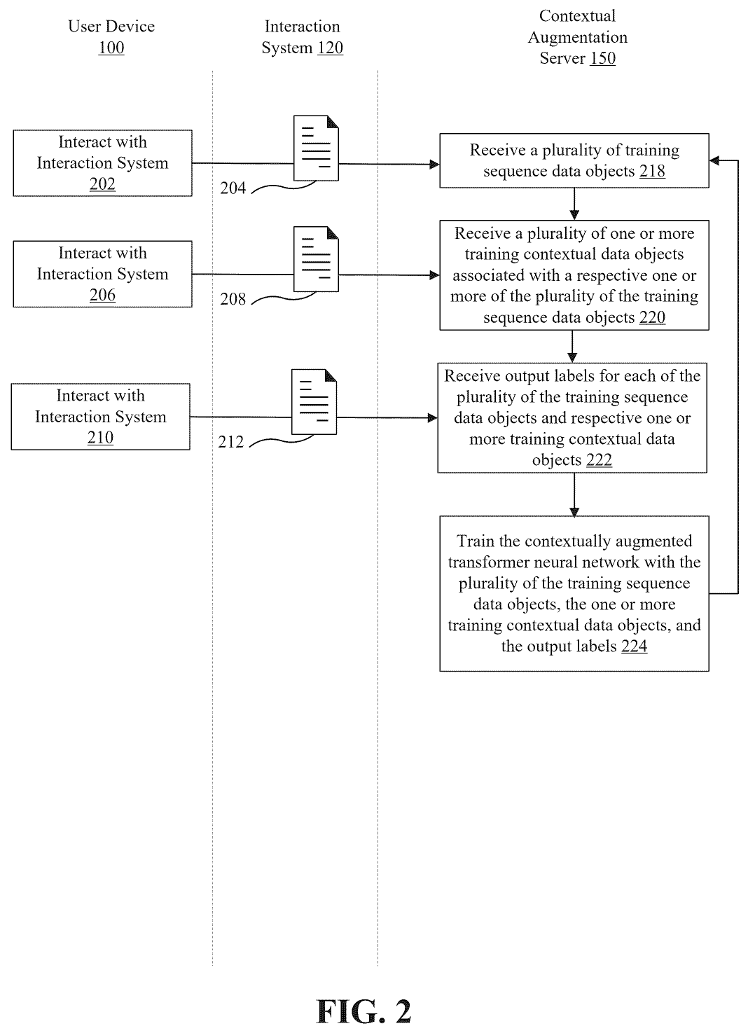

FIG. 2 illustrates an example method for training a contextually augmented transformer neural network with a contextual augmentation server 150 according to example embodiments. At operation 202, the user device 100 interacts with the interaction system 120. For example, operation 202 includes user device 100 interacting with an interaction system 120 to cause the generation of sequential data. For example, the interaction system 120 may be implemented as a transactional system, and a user may initiate purchases at various merchants using a credit card issued by a financial institution associated with the financial institution system. The data 204 may therefore include transactional data, monetary records, or the like. The interaction system 120 transmits data 204 to the contextual augmentation server 150.

Accordingly, at operation 218, the contextual augmentation server 150 receives a plurality of training sequence data objects. It will be appreciated that although operation 218 refers to training sequence data objects, the data 204 may be in a variety of formats, including but not limited to sequential data, tokens, sequence data objects, or the like. In this regard, tokenization may be performed by the interaction system 120 or the contextual augmentation server 150. The training sequence data objects may be stored and maintained on contextual augmentation memory 156. The training sequence data objects may indicate multiple events and respective timestamps. The training sequence data objects may include an entire history of data associated with the entity, or a subset of available data. The training sequence data objects may be updated over time as additional tokens, events, or transactions associated with a respective entity are received.

At operation 206, the user device 100 interacts with the interaction system 120 to cause generation of data 208, which may be a different type of data, or in a different format than data 204. The data 208 may include a subsequence context, token-level context, token-to-token sequence, or token-to-sequence context. For example, the user device 100 accesses a user profile to indicate a birthdate, a marital change status, a change of address, or the like, and such data is provided to the contextual augmentation server 150. As another example, a user makes purchases with and payments toward a credit card account, and the interaction system 120 generates a credit score, as data 208, to be provided to the contextual augmentation server 150. It will be appreciated that according to certain embodiments, the interaction 206 occurs independently from operation 202. For example, a user may provide demographic information in a profile years earlier in comparison to the provision of certain data 204, such as those relating to transactions. The data may include or may be derived from any of subsequence contexts, token-level contexts, or token-to-token contexts.

At operation 220, the contextual augmentation server 150 receives a plurality of one or more training contextual data objects associated with a respective one or more of the plurality of the training sequence data objects. The training contextual data objects may include or may be derived from one or more subsequence contexts, token-level contexts, or token-to-token contexts. The data 204 and 208 may be associated together in various ways, such as for example, having a common associated subject entity or identifier thereof. In this regard, operations 218 and 220 provide that the contextual augmentation server 150 receives a subject sequence data object and one or more subject contextual data objects associated therewith.

At operation 210, the user device 100 interacts with the interaction system 120 to cause generation of data 212 which may include any type of known data. The data 212 may therefore resemble or be of a data type the contextually augmented transformer neural network is configured to predict. The data 212 may be a same or similar typed data as data 204 or data 208. For example, transactional records may be input to the contextually augmented transformer neural network, along with a contextual data object, to enable the contextually augmented transformer neural network to output or predict subsequent transactional records or information describing predicted transactional records.

As another example, credit scores may be input to the contextually augmented transformer neural network, along with a sequence data object to output or predict a future credit score. The data 212 may include any data pertaining to desired outputs of the contextually augmented transformer neural network. For example, output labels may be generated based at least in part on one or more events such as transactional data and may indicate an increase in spending over a particular time window, or an increase in spending in a particular spending category, such as home improvement spending, restaurant spending, etc.

At operation 222, the contextual augmentation server 150 receives output labels for each of the plurality of the training sequence data objects and respective one or more training contextual data objects. The output labels may be automatically generated from data 212 or may be generated based at least on a partially manual process, such as for the purpose of generating training data and training the contextually augmented transformer neural network.

According to certain embodiments, any of operations 202, 206, and 210 may occur independently of the other of operations 202, 206, and 210, and may occur with a same or different instance of a user device 100. Similarly, the interactions of operations 202, 206, and 210 may occur with a same or different instance of an interaction system 120 in comparison to the other of the operations 202, 206, and 210. Although the data 204, 208 and 212 may originate from different sources, certain instances of data 204, 208 and 212 are associated together by a commonality, such as for example, a subject entity or identifier thereof. In this regard, the data 204, 208, and 212 may be associated with the same consumer or user, such that the data 204 and 208 is applied as input to the contextually augmented transformer neural network, and the respective data 212 forms the respective label to be used in training.

According to certain embodiments, the data 204, 208, and 212 need not be explicitly provided by the user device 100, but an interaction with the interaction system 120 via the user device 100 may result in processing of certain data by the interaction system 120, and generation of data 204, 208, or 212. For example, a purchase of an item using a credit card may result in generation of transactional data (e.g., data 204 or data 212) relating to the purchase to be provided to the contextual augmentation server 150.

In this regard, a sequence data object 218 may be generated and received in association with a single communication between a user device 100 and interaction system 120. For example, a user may type and upload a blog post, which is subsequently tokenized and converted to a sequence data object. As another example, a user device 100 initiates a plurality of transactions at different time instances, representative of distinct events, and the events are collectively communicated as a sequence data object to contextual augmentation server 150. As another example, data 204 indicative of events or transactions are communicated to the contextual augmentation server 150 individually and combined by contextual augmentation server 150 to form the sequential data from which a sequence data object(s) are derived.

In operation 224, the contextual augmentation server 150 trains the contextually augmented transformer neural network with the plurality of the training sequence data objects, the one or more training contextual data objects, and the output labels. Although not illustrated in FIG. 2, the contextual augmentation server 150 may generate a contextually augmented transformed neural network prior to beginning training. The contextually augmented transformer neural network may be initially generated such as by populating an attention mechanism as described in further detail herein, with an initial set of data. The contextually augmented transformed neural network may then be updated by training it with additionally received data.

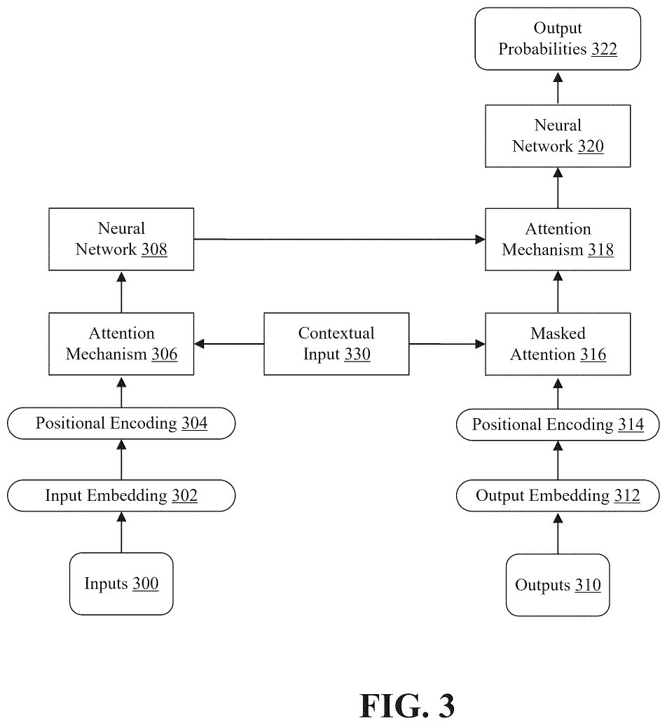

Training of the contextually augmented transformer neural network is described in further detail herein, such as with respect to FIGS. 3-9. According to certain embodiments, the flow may return to operation 218, and certain operations of FIG. 2 may be repeated, such as on an ongoing basis, or as additional data 204, 208 and 212 is received. In this regard, training sequence data objects may be updated or regenerated, and respective training contextual data objects and output labels, received or updated. The contextually augmented transformer neural network may therefore be trained with additional data on an ongoing basis, on a routine interval, in real-time as the data is received, or the like. The trained contextually augmented transformer neural network may be used to generate outputs, such as predictions, as disclosed herein. The use of one or more contextual data objects (including or derived from one or more subsequence contexts, token-level contexts, or token-to-token contexts) promotes improved accuracy and efficiency of the contextually augmented transformer neural network as described herein.

The data 204, 208 and 212 may be in a variety of formats and relate to a variety of uses. For example, data 204 may be natural language text such as text input to a blog or social media site, data 208 may be a profile attribute of the user, and data 212 may include a browsing activity or purchase activity in a browser. In this regard, the contextually augmented transformer neural network may be trained to predict browser activity, or a future purchase based at least in part on the text input and profile attribute. Numerous variations may be contemplated, including those related to natural language processing, computer vision, audio file processing, transactional record processing, or the like.

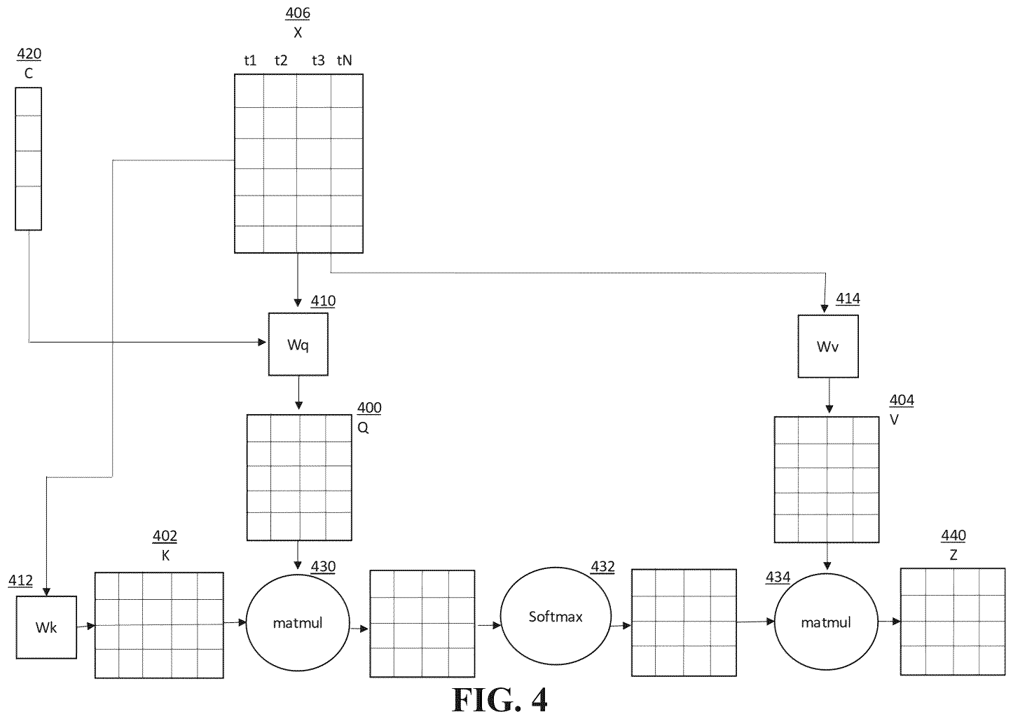

FIG. 3 illustrates a conceptual diagram of a contextually augmented transformer neural network according to certain example embodiments. According to certain embodiments, the left side or left stack of FIG. 3 represents an encoder, and the right side or right stack of FIG. 3 represents a decoder. Inputs 300, such as sequential data objects, or data from which sequential data or sequent data objects are derived, are processed according to example embodiments. Input embedding 302, and positional encoding 304 may be performed on the inputs prior to processing by attention mechanism 306. The attention mechanism 306 may be a self-attention mechanism in accordance with the various embodiments discussed herein. An example of an attention mechanism according to certain embodiments provided herein is described in further detail with respect to FIG. 4. Data generated by the attention mechanism 306 are added to the input embeddings and normalized, and are further processed by a neural network 308, which may also be referred to as a feed-forward neural network. Although not depicted in FIG. 3, the attention mechanism and neural network may have residual connections to pass information between their respective sub-layers and preserve important information.

Techniques described herein can be applied to encoder-only applications, decoder-only applications, or applications that involve both encoders and decoders. In examples, there may be encoder-only applications relating to token classification (e.g., BERT-like tasks, such as fraud detection). Decoder models (e.g., GPT-like models) may be used for use cases like future prediction or prediction generation based on sequences. Both architectures, may serve in general use cases such as behavioral disruptions detection.

The neural network 308 produces representations of the inputs that capture relationships amongst the various tokens of the input. The representations output by the encoder, or outputs 310, are used by the decoder to generate output embeddings 312, offset by one position with respect to the input sequence. Positional encodings 314 are similarly applied as are applied by the encoder. The masked attention 316, which may include masked multi-head attention, prevents attending to future tokens of the sequence, and produces an output, added to the output embeddings and normalized for further processing by an attention mechanism 318 of the decoder. The neural network 320, or feed-forward of the decoder, captures relationships in the output while considering information from the input sequence. The output of the neural network 320 may be linearly transformed and applied to a SOFTMAX function to generate output probabilities 322.

As illustrated, contextual input 330 is provided as input into the attention mechanism 306. In addition or instead, the contextual input 330 is provided as input into the masked attention mechanism 316. In such an instance, the metadata in the input and in the output may be the same. The contextual input 330 can be in the form of embeddings or otherwise processed for use in this way. The contextual input 330 may be processed to generate a contextual data object, which may include any of a subsequence context, a token-level context, a token-to-token context, or a token-to-sequence context. The contextual input 330 may include at least one element not derived from nor derivable from the input sequence, but may also include some elements derived from the input sequence.

FIG. 4 illustrates a data flow according to an attention mechanism, such as attention mechanism 306 according to certain example embodiments. The queries matrix Q (400), keys matrix K (402) and values matrix V (404) are computed as multiplication of the embedded input sequence X, or X matrix (406), by three weighted matrices Wq (410), Wk (412) and Wv (414). Every row in the X matrix corresponds to an element in the input sequence. The columns of the X matrix are the embedded features of each input. In a training phase, the weighted matrices Wq (410) and Wk (412) and Wv (414) are updated and trained via backpropagation using ground truth data, or output labels, for example. The matrices are calculated as:

$$Q = X \cdot {W}_{Q} \\ K = X \cdot {W}_{K} \\ V = X \cdot {W}_{V}$$

The output Z of the self-attention layer is computed as:

$$Z = \frac{SOFTMAX ( Q * K )}{\sqrt{d}} V$$

with Q, K and V having size n×d, and n being the number of element or length of the sequence. In some embodiments, following generation of the output Z, the Z matrix may be averaged or otherwise weighted (e.g., using a weighted matrix Wz) to generate an input to the neural network (e.g., a feed-forward neural network). For example, in some embodiments, the neural network may receive attention vectors generated by Z·Wz.

According to example embodiments, vector C (420), comprising or derived from one or more contextual data objects is further embedded in the attention mechanism. Vector C (420) may include or may be derived from one or more subsequence contexts, token-level contexts, token-to-token contexts, or token-to sequence contexts. For example, vector C (420) is applied to Wq (410), such as by operations involving adding or concatenation. According to certain embodiments, the queries matrix Q (400) is modified by adding contextual data objects.

Certain embodiments of the present disclosure modify the query-key-value mechanism by modifying the Q matrix by adding the contextual data. According to certain embodiments, features of vector C (420) are concatenated to each x element of X (406).

$$Q = concat ( X , repeat ( C , n ) )$$

Here, the term “each” element of X is used because X is a matrix while C is a vector comprising or derived from one or more contextual data objects, thus the vector C is repeated n times and concatenated to all the n entries of X In implementations, this approach can result in at least some redundant contextual information being concatenated to each element x of the input sequence X.

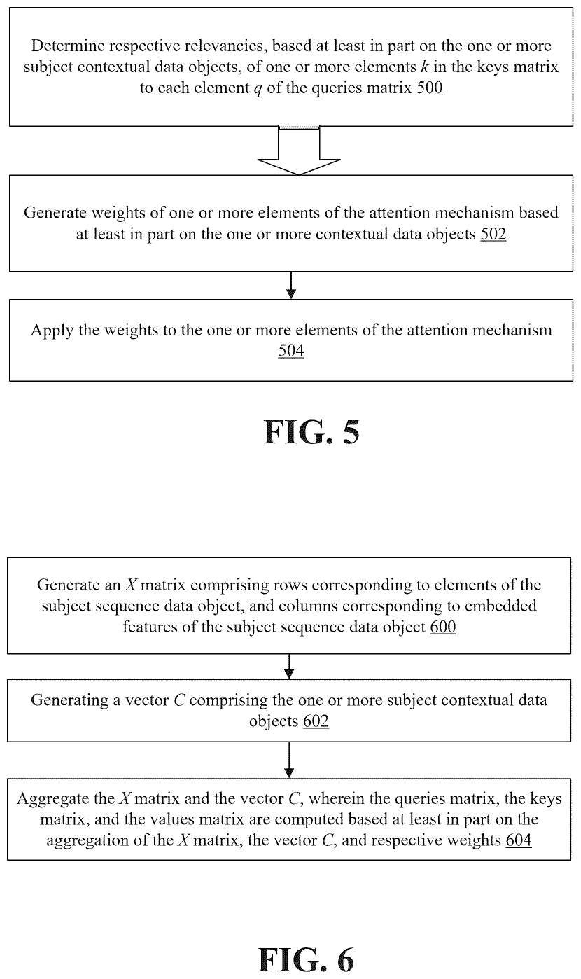

According to certain embodiments, other methods may be used to aggregate the x elements of X (406) and the features of vector C (420) into a matrix. For example, the contextual data object or vector C may be aggregated with the keys matrix K (402). Examples of such methods are described in further detail with respect to FIGS. 5-7.

In some examples, contextual information is added to an input sequence before the embeddings X. In some examples, there may be additional methodologies for embedding C into Q (and/or K).

Continuing with the description of FIG. 4, matrix multiplication, or matmul (430), is performed on the weighted queries matrix Q (400) and weighted keys matrix K (402). A mathematical function, such as SOFTMAX (432) is further applied to the result, and multiplied matmul (434) with the values matrix V (404) to generate a probability distribution Z of attention scores (440).

It will be appreciated that FIG. 4 illustrates an example for embedding contextual data objects in an attention mechanism, and numerous variations may be contemplated. For example, the methods illustrated in FIGS. 5-7 are example methods for embedding contextual data in an attention mechanism according to example embodiments.

As shown in FIG. 5, at operation 500, the contextual augmentation server 150 determines respective relevancies, based on the one or more subject contextual data objects, of one or more elements k in the keys matrix to each element q of the query matrix. The relevancies may be considered one or more weights of one or more elements in the attention mechanism. In some examples, matrix multiplication between Q and K is changed by adding in shared information on the input sequence represented by matrix X and also the contextual info represented in matrix C. This can lead to an improved weighted matrix to finally weight the V matrix. Operation 500 may be performed by performing operations 502 and 504.

At operation 502, the contextual augmentation server 150 generates weights of one or more elements of the attention mechanism based at least in part on the one or more contextual data objects. See for example, FIG. 4, in which the vector C (420) is applied to the Wq (410).

As another example relating to operation 502, see operations 602 and 604 of FIG. 6.

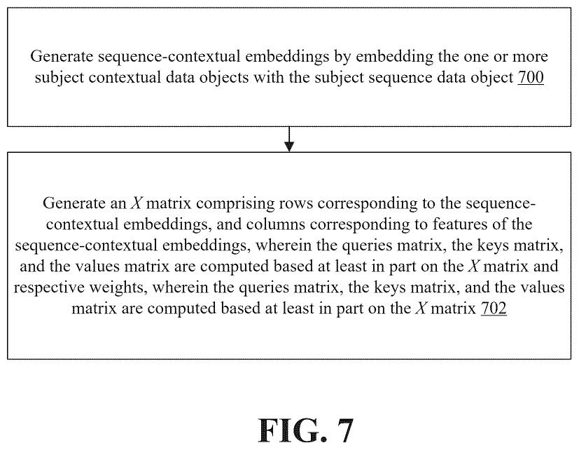

As another example relating to operation 502, see operations 700 and 702 of FIG. 7.

Continuing with the description of FIG. 5, at operation 504, the contextual augmentation server 150 applies the weights to the one or more elements of the attention mechanism. See for example, the weighted queries matrix Q (400) in FIG. 4. See also operation 604 of FIG. 6, and operation 702 of FIG. 7.

In a training phase, operations 500, 502, and 504 may be performed iteratively via backpropagation. In this regard, the contextually augmented transformer neural network of the contextual augmentation server 150 updates the weights and reapplies the updated weights to the attention mechanism. The contextually augmented transformer neural network compares the model's predictions to the ground truth output labels, performs a loss calculation and iteratively updates the model.

At run-time, or application of the contextually augmented transformer neural network to generate outputs or predictions based on an input, the operations 500, 502, and 504 are performed to generate the weights and apply the weights to the elements of the attention mechanism to generate an output.

Determining weights of the contextually augmented transformer neural network based at least in part on at least the contextual data object, provides a more accurate and efficient model than models that don't embed the contextual data object in the attention mechanism. According to certain embodiments of the present disclosure, the attention mechanism may be used to weight not only the sequence-related values matrix V, for a generative reconstruction, but also to future output.

FIG. 6 illustrates another example method for embedding one or more subject contextual data objects in the attention mechanism. According to certain example embodiments, the contextually augmented transformer neural network aggregates the elements sequence matrix X and the contextual data objects, or contextual vector C, into one matrix.

At operation 600, the contextual augmentation server 150 generates an x matrix comprising rows corresponding to elements of the subject sequence data object, and columns corresponding to embedded features of the subject sequence data object.

At operation 602, the contextual augmentation server 150 generates a vector c comprising the one or more subject contextual data objects.

At operation 604, the contextual augmentation server 150 aggregates the x matrix and the vector C, wherein the queries matrix, the keys matrix, and the values matrix are computed based at least in part on the aggregation of the X matrix, the vector C, and respective weights.

FIG. 7 illustrates another example method for embedding one or more subject contextual data objects in the attention mechanism. According to certain embodiments, the contextually augmented transformer neural network embeds the contextual data objects and the input sequence before embedding X, creating a different embedded input matrix X′ that is composed by the embeddings of the aggregated sequence data object and one or more contextual data objects.

At operation 700, the contextual augmentation server 150 generates sequence-contextual embeddings by embedding the one or more subject contextual data objects with the subject sequence data object. In this regard, one or more subsequence contexts, token-level contexts, or token-to-token contexts may be embedded with the subject sequence data object.

At operation 702, the contextual augmentation server 150 generates an x matrix comprising rows corresponding to the sequence-contextual embeddings, and columns corresponding to features of the sequence-contextual embeddings, wherein the queries matrix, the keys matrix, and the values matrix are computed based at least in part on the X matrix and respective weights, wherein the queries matrix, the keys matrix, and the values matrix are computed based at least in part on the X matrix.

The operations of FIGS. 5-7 may be performed by the contextually augmented transformer neural network in a training phase and during run-time execution. In a training phase, the weights may be trained and recalculated via backpropagation.

A same or similar architecture can be applied to different kinds of contextual data, including: subsequence context, token-level context, token-to-token context, and token-to-sequence context. For subsequence contextual information that are external to the transactional input sequence, a traditional self-attention model would not be able to handle them, but mechanisms, such those explained in FIGS. 5-7 can be used to include and embed such contextual information within the attention mechanism of the transformer. Contextual-aware transformers described herein can also be able to or configured to handle and understand contextual data at token-level for contextual data associated with token-level context, token-to-token context and token-to-sequence context.

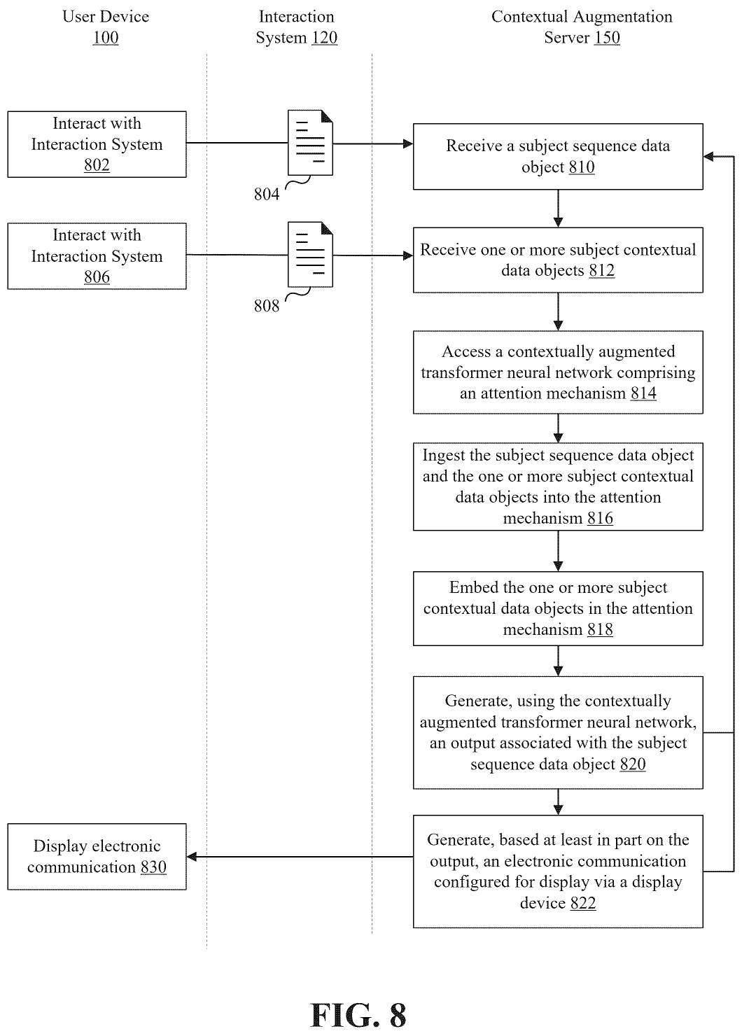

FIG. 8 illustrates an example method for generating an output with the contextually augmented transformer neural network, such as during run-time execution. Operations 802 and 806 includes the user device 100 interacting with the interaction system 120. The operations may be similar to respective operations 202 and 206 of FIG. 2. The data 704 and 808 is generated or received by interaction system 120 and provided to contextual augmentation server 150. The data 704 and 808 may be similar to data 204 and 208 of FIG. 2. The data 704 may be sequential data, a plurality of tokens, a plurality of events, a sequence data object, or the like. The data 704 may have positional encodings such as timestamps. The data 808 may be contextual data and may be a different type of data not included in the data 704. The interactions of operations 802 and 806 may occur with different instances of user device 100, and the data 704 and 808 generated by different instances of the interaction system 120.

As shown by operation 810, the contextual augmentation server 150 receives a subject sequence data object. The subject sequence data object may comprise a plurality of tokens, events, or the like indicative of sequential data or the data 704.

As shown by operation 812, the contextual augmentation server 150 receives one or more subject contextual data objects 812. The subject sequence data object and one or more subject contextual data objects may be associated based at least in part on a common subject entity, identifier thereof, or the like. For example, the subject sequence data object and one or more subject contextual data objects may be associated with the same user.

Operations 810 and 812 therefore provide that the contextual augmentation server 150 receives a subject sequence data object and one or more subject contextual data objects associated therewith.

As shown by operation 814, the contextual augmentation server 150 accesses a contextually augmented transformer neural network comprising an attention mechanism. For example, operation 814 may include accessing the contextually augmented transformer neural network described with respect to FIGS. 2-7. The attention mechanism comprises a mapping of a queries matrix and a key-value pairs to an output matrix, wherein the key-value pairs are derived from a keys matrix and a values matrix.

As shown by operation 816, the contextual augmentation server 150 ingests the subject sequence data object and the one or more subject contextual data objects into the attention mechanism. In this regard, the elements of the attention mechanism are populated based at least in part on data from the subject sequence data object and the one or more subject contextual data objects. See for example, FIGS. 3-7. Operation 816 may include, or may flow to, operation 818.

In operation 818, the contextual augmentation server 150 embeds the one or more subject contextual data objects in the attention mechanism of the contextually augmented transformer neural network. FIGS. 5-7 provide example operations for embedding contextual data objects in the attention mechanism. See also vector C (420) of FIG. 4.

As shown by operation 820, the contextual augmentation server 150 generates, using the contextually augmented transformer neural network, an output associated with the subject sequence data object. In this regard, the contextually augmented transformer neural network takes into account the contextual data object(s) in addition to the sequence data object, in determining the output or prediction.

An output of operation 820 may include but is not limited to a predicted pattern change pertaining to an attribute of a sequence data object. For example, the output, or predicted pattern change, may include a directional indicator, a change type (a category and optional subcategory), a predicted start date or time, a predicted duration, a quantifiable feature, a predicted deviation of the quantifiable feature, a predicted number of events, and a predicted number of events per unit of time. According to certain embodiments, an output attribute may include a probability that a pattern change occurs or does not occur. As an example, an output of operation 820 may include a prediction of increased spending.

Utilizing the contextually augmented transformer neural network in the operations of FIG. 8 provides distinct advantages over systems that fail to embed a contextual data object into the attention mechanism. Example embodiments therefore identify important parts of the sequence data object based at least in part on the contextual data object. For example, a user who has changed their address from a rural location to a metropolitan area known for higher living costs, may have an associated increase in spending on average, or in particular categories such as dining. The contextually augmented transformer neural network provides a more efficient and more accurate prediction of such changes, in comparison to other neural networks that may alternatively analyze the transactional record alone. The contextually augmented transformer neural network more accurately and more efficiently identifies the important part of the sequence data in predicting the pattern change by embedding the contextual data object in the attention mechanism.

Examples can be used to directly associate sequences of transactions to contextual features of the user associated with the transaction. For instance, a machine learning model can more accurately match spending patterns of two similar people (e.g., similar with respect to associated contextual information or a contextual data object) without relying on the sequence of transactions. Unlike traditional approaches that only draw information from within the input sequence patterns (e.g. spending patterns of a person), techniques described herein can also draw information from contextual information (e.g., how two people with similar background/tastes will transact under similar circumstances).

Although not illustrated in FIG. 8, according to certain embodiments, the contextual augmentation server 150 compares an output to a threshold or other condition to determine if processing proceeds to operation 822 or returns to operation 810 to repeat certain operations. For example, the operations of FIG. 8 may be repeated based on additionally received data.

As shown by operation 822, the contextual augmentation server 150 generates, based at least in part on the output, an electronic communication configured for display via a display device. The electronic communication may be generated based on one or more attributes of the output. According to certain embodiments, a lookup may be performed based on one or more attributes, and a template electronic communication retrieved, for example.

According to certain embodiments, the template electronic communication may be populated with information such as from the subject entity's profile. The electronic communication may indicate a marketing opportunity, advertisement, or the like, and may include an enrollment link or other information enabling access to website or application of an interaction system 120 or contextual augmentation server 150, to participate in the opportunity. For example, when transactional data is processed by the contextually augmented transformer neural network, and an increase in spending is predicted further based on the contextual data object, the electronic communication may include an offer for applying for a credit card that includes a reward or rebate for purchases in a certain spending category (such as a category identified in the output).

In examples, a communication may be selected or generated using predefined data or scripts (e.g., a lookup table or decision tree). In further examples, the communication may be selected or generated using a large language model or other artificial intelligence system to produce output based on a prompt.

According to certain embodiments, the electronic communication is transmitted to the user device 100. Although not illustrated in FIG. 4, the electronic communication may be transmitted to the user device 100 via another device or system, such as the interaction system 120. The electronic communication may be transmitted using a variety of protocols or methods, such as electronic mail, secure messaging, or by directing rendering by an application or website with which the user device 100 interacts. Numerous variations may be contemplated. As shown by operation 830, the user device 100 receives and displays the electronic communication. According to certain embodiments, other mediums may be used for communication, including non-electronic communication such as physical mail.

From operation 820 or 822, the process flow may return to operation 810, such that the contextual augmentation server 150 monitors newly received data, applies the data to the model, and generate additional outputs and corresponding electronic communications accordingly. In this regard, data received via one or more interaction systems 120 is continually or routinely monitored, and outputs made or updated for a plurality of entities. The contextual augmentation server 150 can therefore detect sequence data objects or contextual data objects based at least in part on monitoring one or more data sources, and the output is generated in real-time relative to a detection of the data. According to certain embodiments, the contextual augmentation server 150 generates an updated sequence data object by updating the subject sequence data object to include data received based at least in part on monitoring one or more data sources. Responsive to generating the updated subject sequence data object, the contextual augmentation server 150 generates, based at least in part on applying the contextually augmented transformer neural network to the updated sequence data object, an updated output.

Augmenting a transformer neural network with contextual data according to example embodiments improves the efficiency and accuracy of the transformer neural network in making predictions. Embedding the contextual data object in the attention mechanism enables the attention mechanism to more efficiently identify relevant or important portions of the sequence data object. The embedding of the contextual data that is not a part of the sequence data object enables additional discoveries that may not be otherwise made without embedding the contextual data in the attention mechanism.

Example embodiments further provide a high level of accuracy in predictions and can perform continuous automated improvement by updating the contextually augmented transformer neural network and by applying the model to newly received data as it is received, to generate new output accordingly, such as in real-time as the data is received.

Moreover, according to certain embodiments, the contextual augmentation server 150 may store or transmit the output in memory in association with the subject entity, such that one or more computing systems or subsystems can access the output and perform an operation, such as generation of an electronic communication accordingly. In this regard, the contextual augmentation server 150 may provide one or more application programming interfaces (APIs) to enable other systems to perform various processes as a result of the output.

### Example Computing Environment

FIG. 9 discloses a computing environment 900 in which aspects of the present disclosure may be implemented. The computing environment 900 may implement any of the user device 10, interaction system 120, and the contextual augmentation server 150. A computing environment 900 is a set of one or more virtual or physical computers 910 that individually or in cooperation achieve tasks, such as implementing one or more aspects described herein. The computers 910 have components that cooperate to cause output based on input. Example computers 910 include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 900 includes at least one physical computer.

The computing environment 900 may specifically be used to implement one or more aspects described herein. In some examples, one or more of the computers 910 may be implemented as a user device, such as mobile device and others of the computers 910 may be used to implement aspects of a machine learning framework useable to train and deploy models exposed to the mobile device or provide other functionality, such as through exposed application programming interfaces.

The computing environment 900 can be arranged in any of a variety of ways. The computers 910 can be local to or remote from other computers 910 of the computing environment 900. The computing environment 900 can include computers 910 arranged according to client-server models, peer-to-peer models, edge computing models, other models, or combinations thereof.

In many examples, the computers 910 are communicatively coupled with devices internal or external to the computing environment 900 via a network 190, such as described with respect to FIG. 1.

In some implementations, computers 910 can be general-purpose computing devices (e.g., consumer computing devices). In some instances, via hardware or software configuration, computers 910 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 910 include one or more processors 912, memory 914, and one or more interfaces 918. Such components can be virtual, physical, or combinations thereof.

The one or more processors 912 are components that execute instructions, such as instructions that obtain data, process the data, and provide output based on the processing. The one or more processors 912 often obtain instructions and data stored in the memory 914. The one or more processors 912 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 912 include at least one physical processor implemented as an electrical circuit. Example providers of processors 912 include INTEL, AMD, QUALCOMM, TEXAS INSTRUMENTS, and APPLE.

The memory 914 is a collection of components configured to store instructions 916 and data for later retrieval and use. The instructions 916 can, when executed by the one or more processors 912, cause execution of one or more operations that implement aspects described herein. In many examples, the memory 914 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, transitory memory 914 can store information encoded in transient signals.

The one or more interfaces 918 are components that facilitate receiving input from and providing output to something external to the computer 910, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The one or more interfaces 918, such as a communication interface, can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces 918 can facilitate connection of the computing environment 900 to a network 190.

The computers 910 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Example Machine Learning Framework

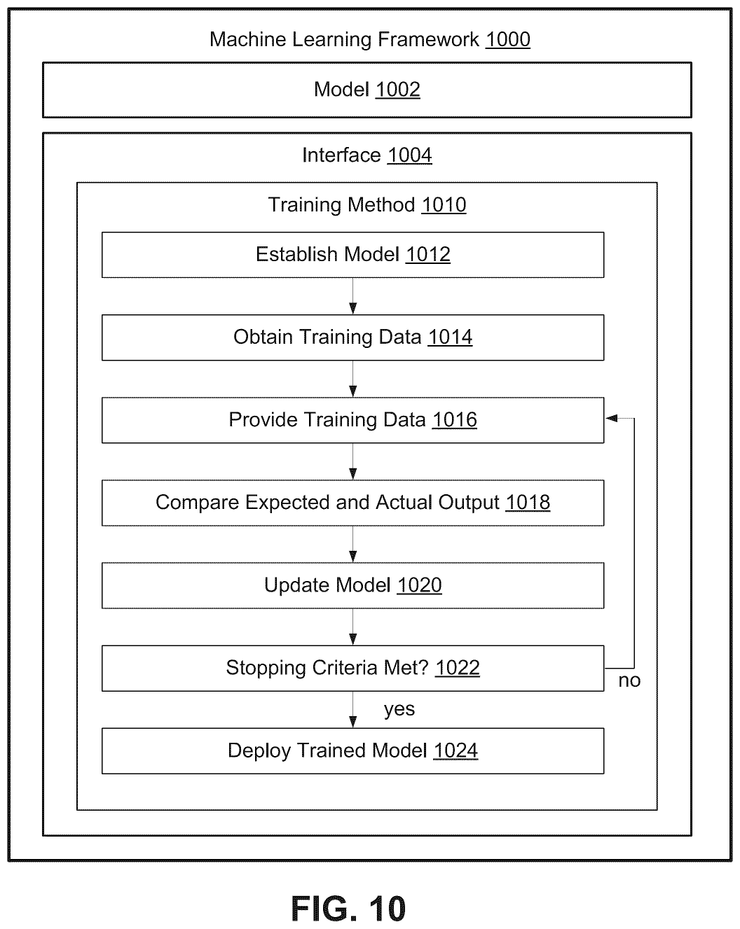

FIG. 10 illustrates an example machine learning framework 1000 that techniques described herein may benefit from or improve on. A machine learning framework 1000 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 1000 or components thereof are often built or refined from existing frameworks, such as TENSORFLOW by GOOGLE, INC. or PYTORCH by the PYTORCH community.

The machine learning framework 1000 can include one or more models 1002 that are the structured representation of learning and an interface 1004 that supports use of the model 1002. The model 1002 may include the contextually augmented transformer neural network and can take any of a variety of forms. In many examples, the model 1002 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 1002 can include a representation of memory (e.g., providing long short-term memory functionality). Where the set includes more than one model 1002, the models 1002 can be linked, cooperate, or compete to provide output.

The interface 1004 can include software procedures (e.g., defined in a library) that facilitate the use of the model 1002, such as by providing a way to establish and interact with the model 1002. For instance, the software procedures can include software for receiving input, preparing input for use (e.g., by performing vector embedding, such as using Word2Vec, BERT, or another technique), processing the input with the model 1002, providing output, training the model 1002, performing inference with the model 1002, fine tuning the model 1002, other procedures, or combinations thereof.

In an example implementation, interface 1004 can be used to facilitate a training method 1010. The training method 1010 may therefore include or be used to implement operation 224 of FIG. 2. The training method 1010 may include operation 1012, which includes establishing a model 1002, such as initializing a model 1002. The establishing can include setting up the model 1002 for further use (e.g., by training or fine tuning). The model 1002 can be initialized with values. In examples, the model 1002 can be pretrained.

Operation 1014 can follow operation 1012. Operation 1014 includes obtaining training data, such as described with respect to one or more data 204, data 208, and operations 218 and 220 of FIG. 2. In many examples, the training data includes pairs of input (e.g., training sequence data objects and respective contextual data objects) and desired output (e.g., labels) given the input. In supervised or semi-supervised training, the data can be prelabeled, such as by human or automated labelers. In unsupervised learning the training data can be unlabeled.

A contextually augmented transformer neural network described herein can be trained in a supervised way if labels are available, such as for token classification, sequence classification, other uses, or combinations thereof. Additionally or alternatively, a contextually augmented transformer neural network may be trained in an unsupervised way, such as in auto-regressive training, where given a sequence of tokens, the subsequence of tokens from 1 to N−1 are used to predict the token at N. Predictions of N may therefore be generated when 2<=N<length(sequence). In contextually augmented transformer neural networks, there can be training settings indicating to predict contextual information (or a portion of the contextual information) given the input data.

Many examples herein are related to supervised prediction of disruptions to pinpoint the weights or importance of events. But certain embodiments may operate without explicit labels but with implicit labels computed based on other data. Thus data need not be explicitly labeled. But it can be beneficial to use an input labeler to infer labels and to train a supervised model.

The training data can include validation data used to validate the trained model 1002. Operation 1016 can follow operation 1014. Operation 1016 includes providing a portion of the training data to the model 1002. This can include providing the training data in a format usable by the model 1002. The machine learning framework 1000 (e.g., via the interface 1004) can cause the model 1002 to produce an output based on the input.

Operation 1018 can follow operation 1016. Operation 1018 includes comparing the expected output with the actual output. In an example, this can include applying a loss function to determine the difference between expected and actual data. This value can be used to determine how training is progressing. Operation 1020 can follow operation 1018. Operation 1020 includes updating the model 1002 based on the result of the comparison. This can take any of a variety of forms depending on the nature of the model 1002. Where the model 1002 includes weights, the weights can be modified to increase the likelihood that the model 1002 will produce correct output given an input. Depending on the model 1002, backpropagation or other techniques can be used to update the model 1002.

Operation 1022 can follow operation 1020. Operation 1022 includes determining whether a stopping criterion has been reached, such as based on the output of the loss function (e.g., actual value or change in value over time). In addition, or instead, whether the stopping criterion has been reached can be determined based on a number of training epochs that have occurred or an amount of training data that has been used. In some examples, satisfaction of the stopping criterion can include if the stopping criterion has not been satisfied, the flow of the method can return to operation 1014. If the stopping criterion has been satisfied, the flow can move to operation 1022.

Operation 1024 includes deploying the trained model 1002 for use in production, such as providing the trained model 1002 with real-world input data and produce output data used in a real-world process, such as provided with respect to FIG. 3. The model 1002 can be stored in memory 914 of at least one computer 910 or distributed across memories of two or more such computers 910 for production of output data. The model 1002 may include or implement the contextually augmented transformer neural network and may be stored on contextual augmentation memory 156.

The use of a computer and network implemented system in generating outputs, and associated electronic communications, enables leveraging of machine learning processes, neural networks, and attention mechanisms to efficiently extract meaningful outputs from large datasets, by embedding respective contextual data in the attention mechanism along with respective sequence data objects. Accordingly, example embodiments provide improvements over systems that merely process input sequences, or sequence data objects, without context. The improvements may be realized with input data that spans long timeframes of multiple sequence events. The generated outputs are also more accurate and are able to detect latent and hidden relationships between multiple sequenced events.

Example embodiments may simultaneously consider multiple types of contextual data objects (e.g., subsequence contexts, token-level contexts, and token-to-token contexts). Example embodiments, learn, understand, and predict latent pattern of data not only considering the sequence data object, such as transactional data, but further contextualize each sequence within its context—including any known subsequence contexts, token-level contexts, and token-to-token contexts. Example embodiments further leverage the attention mechanism to provide an importance scoring or weighting of the features within an input sequence as well as in the contextual data.

Additionally, example embodiments may create one model across all subjects and entities, to make generalization across users, demographics, or other groupings of people or entire populations. Example embodiments may therefore generate a foundational model that directly enables various downstream application and tasks such as those relating to forecasting, attrition, marketing, or the like.

By sharing model parameters and applying transfer learning techniques across customers, example embodiments can leverage the knowledge gained from one customer's transactional data to improve the forecasting for another. This transfer of learning allows the model to generalize across customers and capture common patterns and trends, resulting in more accurate predictions.

Moreover, the use of subsequence contexts, token-level contexts, and token-to-token contexts as contextual data embedded in the attention mechanism provides that the contextual data is known to be true for the given sequence data object or associated entity. In contrast, merely utilizing semantic context, such as may be derived from a natural language input, relies on inferences to be made by the model, which may introduce inaccurate data and inefficient training or processing of input data at run-time. The use of true data as contextual data objects embedded in the attention mechanism provides significant insight for the model to learn the impacts of such contextual data object relative to sequence data objects, to make predictions about the future patterns of the sequences, other outputs, or the like. Example embodiments therefore provide improvements over alternative models that are limited to analyzing data of only a single type (such as for example, models that process input sequences as their only input). Moreover, example embodiments provide an accurate and efficient machine learning environment for generating outputs that is not possible or practical to replicate in a human domain or generic computing environment. A contextually augmented transformer neural network according to example embodiments disclosed herein can utilize additional contextual information (e.g., contextual data object including a subsequence context, token-level context, token-to-token context, or toke-to-sequence context) that is different than a semantic context that may be derived purely from a sequence data object or input sequence, such as is performed in traditional NLP implementations. In cases like financial transaction data and biosensor monitoring, there is much information about the entity and concurrent context that traditional transformer architectures do not utilize.

Example embodiments may be integrated with a variety of interaction systems 120, to generate meaningful and intelligent outputs. Such integration may provide a non-routine application of contextual data in the attention mechanism, along with the sequence data object to generate outputs. The accuracy of such predictions may be improved in comparison to attention mechanism that use merely sequence data as inputs or fail to include contextual data in the input that is not a part of the input sequence or sequence data object.

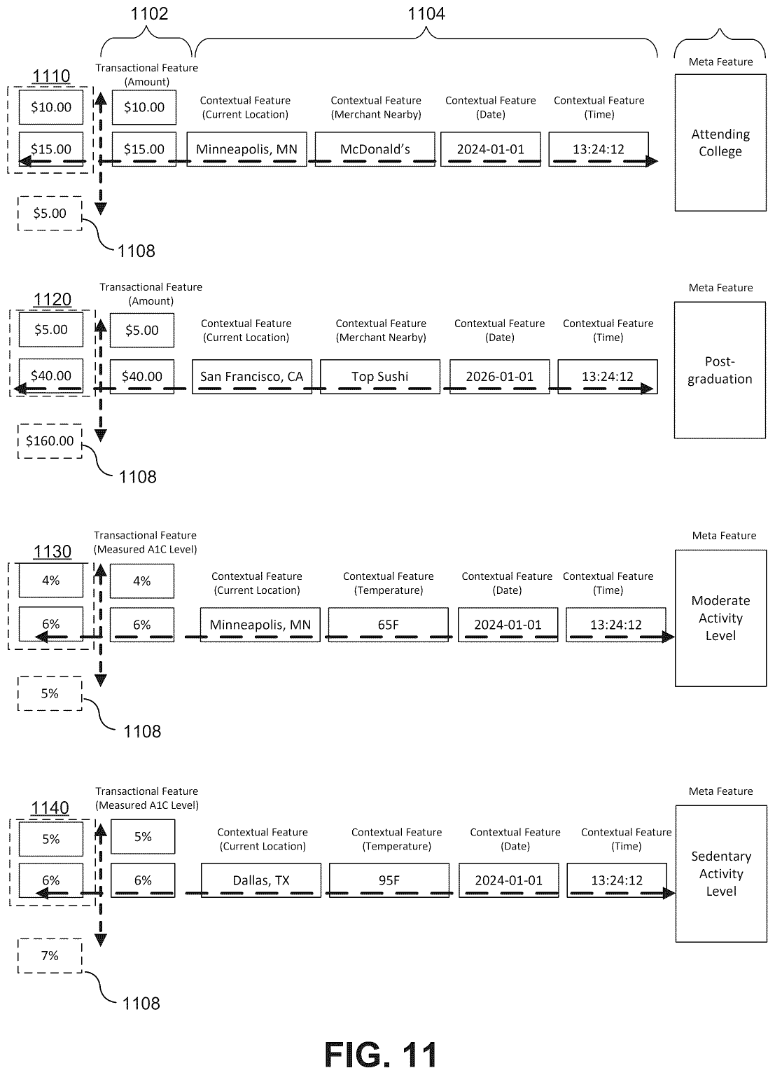

FIG. 11 illustrates example sequences 1110, 1120, 1130, 1140 and associated transactional features 1102 (e.g., token-to-token context), contextual features 1104 (e.g., token-level context), and meta features 1106 (e.g., subsequence context) upon which transaction predictions 1108 are made, such as using techniques described herein. The contextual features 1104 can be immediate features with respect to a transaction, and the meta features 1106 are relatively longer-term features with respect to multiple transactions. The dashed directional lines represent the dimensionality of transactional features, the input sequence, and the contextual features. In this regard, the vertical dashed directional line indicates the temporal or sequential view used to generate the transactional feature, and the horizontal dashed directional line indicates the lateral view within a particular token of the contextual feature. The feature components of the sequences can be received separately and combined, received together, or combinations thereof. For instance, in some examples, a transaction is received, then additional transactions are received to build the transactional features 1102. The contextual features 1104 and meta features 1106 are then obtained and associated together with the sequence. In other examples, some or all of the components are received together (e.g., a transaction is obtained with its contextual features). The input sequences 1110, 11120, 1130, and 1140 (e.g., sequence data object), respective transactional features (1102), respective contextual features 1104, and respective meta features 1106 may be combined such as described with respect to FIG. 4 and as discussed herein.

The first example sequence 1110 and the second example sequence 1120 relate to monetary transactions and the transactional feature 1102 is made up of a current transaction and a set of prior transactions. In the illustrated example, the transaction feature 1102 is made up of individual transactions having specific transaction amounts. The contextual features 1104 for each of the transactions in these sequences 1110 and 1120 include a current location (city and state), a nearby merchant, a date that the transaction occurred, and a time at which the transaction occurred. Further, across multiple transactions, there are one or more shared meta features 1106. In the first sequence 1110, the meta feature is that the person associated with the transaction is attending college. In the second sequence 1120, the meta feature is that the person associated with the transaction has graduated college. The meta feature may be obtained from a database or data source that is separate from a transactional database or transactional data source from which the input is obtained. For example, the meta feature may be obtained from user profile data, a third party data source, or the like.

The third example sequence 1130 and the fourth example sequence 1140 relate to biosensor transactions and the transaction feature 1102 is made up of a series of measured A1C levels (each being a transaction, or event). The contextual features 1104 for each of the transactions in these contexts 1110 and 1120 include a current location (city and state), a current ambient temperature, the date of the transaction, and the time of the transaction. Further, across multiple transactions, there are shared meta features 1106. In the third and fourth sequences 1130, 1140, the meta feature is the individual's activity level (moderate and sedentary activity levels, respectively).

### Additional Example Applications

Example embodiments provided herein enable portability and scalability across a wide array of computing systems. For example, embodiments of the contextually augmented transformer neural network described herein may facilitate training and execution of the transformer more quickly and may produce more accurate results using less data than typical transformers due to more accurate focus provided by adding the contextual information to the self-attention mechanism. Similarly, the transformer neural networks augmented according to the augmented self-attention mechanism embodiment described herein may function for novel applications for which the contextual information provides improved usability, including but not limited to transaction data analysis and predictions such as cybersecurity analysis (e.g., predictions made based on network traffic data), fraud detection (e.g., predictions made based on transaction sequences), and biosensor monitoring.

Some embodiments of the transformer neural networks according to the present disclosure may be configured to receive as inputs non-natural-language and/or non-textual input data (e.g., image data, numerical data, temporal data, other transactional data, etc.). Some embodiments of the transformer neural networks according to the present disclosure may be configured to receive an input sequence comprising data from multiple domains (e.g., two or more of image data, numerical data, temporal data, other transactional data, etc.). Some embodiments of the transformer neural networks according to the present disclosure may be configured to output textual or non-textual outputs, including computer program instructions configured to cause a computing system to carry out a resolution to an issue detected via the transformer neural network (e.g., locking a user account upon detection of fraud, cybersecurity, risk, etc.).

Techniques described herein can be applied to sensor data, such as medical sensor data. In an example, data can be obtained from one or more implanted or wearable sensors. Example sensors include imaging sensors (e.g., ultrasound sensors, x-ray sensors, magnetic resonance sensors, optical sensors, other imaging sensors, or combinations thereof), gyroscopic sensors, magnetic sensors, temperature sensors, humidity sensors, heart rate sensors, blood pressure sensors, blood glucose sensors, electrodes (e.g., sensors for sensing nerve impulses or other electric signals of the body), chemical sensors, other sensors useful in the medical context, or combinations thereof. Raw or processed readings (e.g., which can be referred to as transactions) from such sensors can be combined with context surrounding such readings and processed using techniques herein. The result of such processing can include predictions, which can be used to assist in the diagnosis or treatment of a condition of a patient. In some examples, one or more processors configured to perform techniques described herein can be included within a housing of a medical device and used to effectuate treatment.

Techniques herein may be applicable to improving technological aspects of transactions (e.g., resisting fraud, entering loan agreements, transferring financial instruments, or facilitating payments). Although technology may be used in the context of processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single soft are product or packaged into multiple software products.

Thus, embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The various embodiments described herein are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims. Although specific terms are employed herein, they are used in a generic and descriptive sense only and not for purposes of limitation.

That which is claimed:

1. A system comprising one or more processors and at least one non-transitory memory having instructions that, when executed by the one or more processors, cause the one or more processors to:
receive a subject sequence data object and one or more subject contextual data objects associated therewith;
access a contextually augmented transformer neural network comprising an attention mechanism, wherein the attention mechanism comprises a queries matrix, a keys matrix, and a values matrix;
ingest the subject sequence data object and the one or more subject contextual data objects into the attention mechanism;
embed the one or more subject contextual data objects in the attention mechanism; and
generate, using the contextually augmented transformer neural network, an output associated with the subject sequence data object.

2. The system according to claim 1, wherein the instructions, that when executed by the one or more processors, further cause the one or more processors to:
generate, based at least in part on the output, an electronic communication configured for display via a display device; and
transmit the electronic communication to a computing device associated with a subject entity associated with the subject sequence data object.

3. The system according to claim 1, wherein embedding the one or more subject contextual data objects in the attention mechanism comprises:
determining respective relevancies, based at least in part on the one or more subject contextual data objects, of one or more elements kin the keys matrix to each element q of the queries matrix.

4. The system according to claim 3, wherein determining the respective relevancies comprises:
generating weights of one or more elements of the attention mechanism based at least in part on the one or more subject contextual data objects; and
applying the weights to the one or more elements of the attention mechanism.

5. The system according to claim 1, wherein the instructions, that when executed by the one or more processors, further cause the one or more processors to:
receive a plurality of training sequence data objects;
receive a plurality of one or more training contextual data objects associated with a respective one or more of the plurality of the training sequence data objects;
receive output labels for each of the plurality of the training sequence data objects and respective one or more training contextual data objects; and
train the contextually augmented transformer neural network with the plurality of the training sequence data objects, the one or more training contextual data objects, and the output labels.

6. The system according to claim 1, wherein the subject sequence data object comprises one or more tokens derived from sequential data, and positional encodings indicating the one or more tokens' respective positions within the sequential data.

7. The system according to claim 1, wherein the subject sequence data object is derived from one or more transactional records.

8. The system according to claim 1, wherein the subject sequence data object is derived from one or more of natural language text, an image, or an audio file.

9. The system according to claim 1, wherein the one or more subject contextual data objects comprise one or more subsequence contexts.

10. The system according to claim 9, wherein the one or more subsequence contexts comprise one or more demographic attributes of a subject entity associated with the subject sequence data object.

11. The system according to claim 1, wherein the attention mechanism comprises a self-attention mechanism.

12. The system according to claim 1, wherein the one or more subject contextual data objects comprise one or more token-level contexts.

13. The system according to claim 12, wherein the subject sequence data object is derived from a plurality of events, at least one of the token-level contexts applies to one or more of the plurality of events.

14. The system according to claim 1, wherein the one or more subject contextual data objects comprise one or more token-to-token contexts.

15. The system according to claim 14, wherein the subject sequence data object comprises a plurality of events, and wherein the one or more token-to-token contexts comprise one or more contexts of one or more of the plurality of events relative to one or more contexts of one or more other events of the plurality of events.

16. The system according to claim 1, wherein embedding the one or more subject contextual data objects in the attention mechanism comprises adding the one or more subject contextual data objects to the queries matrix.

17. The system according to claim 1, wherein embedding the one or more subject contextual data objects in the attention mechanism comprises:
generating an X matrix comprising rows corresponding to elements of the subject sequence data object, and columns corresponding to embedded features of the subject sequence data object;
generating a vector C comprising the one or more subject contextual data objects; and
aggregating the x matrix and the vector C, wherein the queries matrix, the keys matrix, and the values matrix are computed based at least in part on the aggregation of the X matrix, the vector C, and respective weights.

18. The system according to claim 1, wherein embedding the one or more subject contextual data objects in the attention mechanism comprises:
generating sequence-contextual embeddings by embedding the one or more subject contextual data objects with the subject sequence data object; and
generating an X matrix comprising rows corresponding to the sequence-contextual embeddings, and columns corresponding to features of the sequence-contextual embeddings, wherein the queries matrix, the keys matrix, and the values matrix are computed based at least in part on the X matrix and respective weights, wherein the queries matrix, the keys matrix, and the values matrix are computed based at least in part on the X matrix.

19. A non-transitory computer readable medium having instructions that, when executed by one or more processors, cause the one or more processors to:
receive a subject sequence data object and one or more subject contextual data objects associated therewith;
access a contextually augmented transformer neural network comprising an attention mechanism, wherein the attention mechanism comprises a queries matrix, a keys matrix, and a values matrix;
ingest the subject sequence data object and the one or more subject contextual data objects into the attention mechanism;
embed the one or more subject contextual data objects in the attention mechanism; and
generate, using the contextually augmented transformer neural network, an output associated with the subject sequence data object.

20. A computer-implemented method comprising:
receiving a subject sequence data object and one or more subject contextual data objects associated therewith;
accessing a contextually augmented transformer neural network comprising an attention mechanism, wherein the attention mechanism comprises a queries matrix, a keys matrix, and a values matrix;
ingesting the subject sequence data object and the one or more subject contextual data objects into the attention mechanism;
embedding the one or more subject contextual data objects in the attention mechanism; and
generating, using the contextually augmented transformer neural network, an output associated with the subject sequence data object.
